(19) United States
(12) Patent Application Publication
(10) Pub. No.: US 2026/0177743 A1
(43) Pub. Date: Jun. 25, 2026

(54) OPTICAL MODULE

(71) Applicant: HISENSE BROADBAND MULTIMEDIA TECHNOLOGIES CO., LTD., Qingdao (CN)

(72) Inventors: Shaoshuai SUI, Qingdao (CN); Sitao CHEN, Qingdao (CN); Fangyuan MENG, Qingdao (CN); Yang LI, Qingdao (CN); Zhiheng SHEN, Qingdao (CN); Xuelei ZHANG, Qingdao (CN); Hongmin CHEN, Qingdao (CN)

(21) Appl. No.: 19/540,029

(22) Filed: Feb. 13, 2026

Related U.S. Application Data
(63) Continuation of application No. PCT/CN2024/112870, filed on Aug. 16, 2024.

(30) Foreign Application Priority Data
Aug. 18, 2023 (CN) 202311043637.4
Aug. 25, 2023 (CN) 202311082694.3
May 21, 2024 (CN) 202410630675.8
Jul. 24, 2024 (CN) 202410998365.1

(51) Int. Cl. G02B 6/12; G02B 6/125; G02F 1/025; G02F 1/225

(52) U.S. Cl. CPC G02B 6/12004; G02B 6/125; G02F 1/025; G02F 1/225

(57) ABSTRACT

An optical module including a light source having a laser assembly, the laser assembly includes a semiconductor gain chip and a wavelength tuning chip. The wavelength tuning chip includes at least one microring filter configured to filter out a beam with a specific wavelength from a beam emitted by the semiconductor gain chip. The microring filter includes a first slab region and a second slab region located on both sides of a silicon waveguide ridge region and contact electrodes. An N-type doped region is provided in the first slab region, and a P-type doped region is provided in the second slab region. The P-type doped region and N-type doped region form a PN junction electrically connected to the contact electrodes. Applying a reverse bias to the PN junction can absorb electron hole pairs in the silicon waveguide ridge region, the first slab region and the second slab region.

The present disclosure is a continuation application of an international Application No. PCT/CN2024/112870, filed on Aug. 16, 2024, which claims priority to Chinese Patent Application No. 202410630675.8, filed with the China National Intellectual Property Administration on May 21, 2024, claims priority to Chinese Patent Application No. 202410998365.1, filed with the China National Intellectual Property Administration on Jul. 24, 2024, claims priority to Chinese Patent Application No. 202311082694.3, filed with the China National Intellectual Property Administration on Aug. 25, 2023, and claims priority to Chinese Patent Application No. 202311043637.4, filed with the China National Intellectual Property Administration on Aug. 18, 2023, all of the above-mentioned applications are incorporated herein by reference in their entirety.

### FIELD OF THE INVENTION

The present disclosure relates to the field of optical fiber communication technology, and in particular, to an optical module.

### BACKGROUND OF THE INVENTION

In new services and application models such as cloud computing, mobile Internet, and video, optical communication technology is widely used. In optical communication, the optical module is a device that enables the conversion between optical and electrical signals, and it is one of the key devices in optical communication equipments.

### SUMMARY OF THE INVENTION

Embodiments of the present disclosure provide an optical module, and the optical module includes:
a circuit board;
an optical chip, electrically connected to the circuit board; and
a light source, including a laser assembly, where the laser assembly is electrically connected to the circuit board, and is configured to generate a beam with a specific wavelength and input the beam into the optical chip; the laser assembly includes a semiconductor gain chip and a wavelength tuning chip, the semiconductor gain chip is configured to emit a beam in a wavelength range, and the wavelength tuning chip and the semiconductor gain chip form a resonant cavity, where the wavelength tuning chip includes:
an input coupler, configured to receive a beam emitted by the semiconductor gain chip and transmit a beam with a specific wavelength to the semiconductor gain chip;
a power splitter, connected to the input coupler, where the power splitter is configured to split the beam input from the input coupler; and
at least one microring filter, connected to an output end of the power splitter, where the microring filter is configured to filter out the beam with a specific wavelength from the beam in a wavelength range;
the microring filter includes a silicon waveguide ridge region, a first slab region, and a second slab region; the silicon waveguide ridge region is configured to transmit the beam and generate electron hole pairs during the transmission of the beam; the first slab region is located on one side of the silicon waveguide ridge region, and an N-type doped region is provided in the first slab region; and the second slab region is located on the other side of the silicon waveguide ridge region, a P-type doped region is provided in the second slab region, the P-type doped region and the N-type doped region form a PN junction, and the PN junction is configured to absorb the electron hole pairs in the silicon waveguide ridge region, the first slab region, and the second slab region.

An embodiment of the present disclosure further provides an optical module, and the optical module includes:
a circuit board;
an optical chip, electrically connected to the circuit board; and
a light source, including a laser assembly, where the laser assembly is electrically connected to the circuit board, and is configured to generate a beam with a specific wavelength and input the beam into the optical chip; and the laser assembly includes a semiconductor gain chip and a wavelength tuning chip, the semiconductor gain chip is configured to emit a beam in a wavelength range, and the wavelength tuning chip and the semiconductor gain chip form a resonant cavity, where the wavelength tuning chip includes:
at least one microring filter, where the microring filter is configured to filter out the beam with a specific wavelength from the beam in a wavelength range; and
the microring filter includes a silicon waveguide ridge region, a first slab region, and a second slab region; the silicon waveguide ridge region is configured to transmit the beam and generate electron hole pairs during the transmission of the beam; the first slab region is located on one side of the silicon waveguide ridge region, and an N-type doped region is provided in the first slab region; and the second slab region is located on the other side of the silicon waveguide ridge region, a P-type doped region is provided in the second slab region, the P-type doped region and the N-type doped region form a PN junction, and the PN junction is configured to absorb the electron hole pairs in the silicon waveguide ridge region, the first slab region, and the second slab region;
the first slab region is located on an outer side of the silicon waveguide ridge region, the first slab region surrounds the silicon waveguide ridge region, and the N-type doped region surrounds the silicon waveguide ridge region; and
the second slab region is located on an inner side of the silicon waveguide ridge region, and the silicon waveguide ridge region surrounds the second slab region and surrounds the P-type doped region.

An embodiment of the present disclosure further provides an optical module, and the optical module includes:
a circuit board;
an optical chip, electrically connected to the circuit board; and
a light source, including a laser assembly, where the laser assembly is electrically connected to the circuit board, and is configured to generate a beam with a specific wavelength and input the beam into the optical chip; and the laser assembly includes a semiconductor gain chip and a wavelength tuning chip, the semiconductor gain chip is configured to emit a beam in a wavelength range, and the wavelength tuning chip and the semiconductor gain chip form a resonant cavity, where the wavelength tuning chip includes:
an input coupler, configured to receive a beam emitted by the semiconductor gain chip and transmit the beam with a specific wavelength to the semiconductor gain chip;
a power splitter, connected to the input coupler, where the power splitter is configured to split the beam input from the input coupler; and
at least one microring filter, connected to an output end of the power splitter, where the microring filter is configured to filter out the beam with a specific wavelength from the beam in a wavelength range;
the microring filter includes a silicon waveguide ridge region, a first slab region, and a second slab region; the silicon waveguide ridge region is configured to transmit the beam and generate electron hole pairs during the transmission of the beam; the first slab region is located on one side of the silicon waveguide ridge region, and an N-type doped region is provided in the first slab region; and the second slab region is located on the other side of the silicon waveguide ridge region, a P-type doped region is provided in the second slab region, the P-type doped region and the N-type doped region form a PN junction, and the PN junction is configured to absorb the electron hole pairs in the silicon waveguide ridge region, the first slab region, and the second slab region; and
the contact electrodes are electrically connected to the P-type doped region and the N-type doped region to supply power to the P-type doped region and the N-type doped region.

### BRIEF DESCRIPTION OF THE DRAWINGS

To more clearly illustrate the technical solution in the embodiments of the present disclosure, the accompanying drawings that need to be used in the description of the embodiments or the prior art will be briefly introduced below. Apparently, the accompanying drawings in the description below merely illustrate some embodiments of the present disclosure. Those of ordinary skill in the art may also derive other accompanying drawings from these accompanying drawings without creative efforts.

FIG. 1 is a partial structural diagram of an optical communication system according to some embodiments of the present disclosure;

FIG. 2 is a partial structural diagram of a host computer according to some embodiments of the present disclosure;

FIG. 3 is a structural diagram of an optical module according to some embodiments of the present disclosure;

FIG. 4 is an exploded view of an optical module according to some embodiments of the present disclosure;

FIG. 5 is a partial structural diagram of an optical module according to some embodiments of the present disclosure;

FIG. 6 is a structural diagram of a light source assembly in an optical module according to some embodiments of the present disclosure;

FIG. 7 is an exploded view of a light source assembly in an optical module according to some embodiments of the present disclosure;

FIG. 8 is a cross-sectional view of a light source assembly in an optical module according to some embodiments of the present disclosure;

FIG. 9 is a schematic diagram of a wavelength tuning chip in an optical module according to some embodiments of the present disclosure;

FIG. 10 is a schematic diagram of an operating principle of a wavelength tuning chip in an optical module according to some embodiments of the present disclosure;

FIG. 11 is a structural diagram of a microring filter in an optical module according to some embodiments of the present disclosure;

FIG. 12 is a cross-sectional view of a microring filter in an optical module according to some embodiments of the present disclosure;

FIG. 13 is an optical path diagram of a light source assembly in an optical module according to some embodiments of the present disclosure;

FIG. 14 is a partial structural diagram of an optical module according to some embodiments of the present disclosure;

FIG. 15 is a first lateral cross-sectional view of an edge coupler in an optical module according to some embodiments of the present disclosure;

FIG. 16 is a top view of an edge coupler in an optical module according to some embodiments of the present disclosure;

FIG. 17 is an A-A cross-sectional view in FIG. 16;

FIG. 18 is a B-B cross-sectional view in FIG. 16;

FIG. 19 is a C-C cross-sectional view in FIG. 16;

FIG. 20 is a D-D cross-sectional view in FIG. 16;

FIG. 21 is an E-E cross-sectional view in FIG. 16;

FIG. 22 is a second lateral cross-sectional view of an edge coupler in an optical module according to some embodiments of the present disclosure;

FIG. 23 is a third lateral cross-sectional view of an edge coupler in an optical module according to some embodiments of the present disclosure;

FIG. 24 is a fourth lateral cross-sectional view of an edge coupler in an optical module according to some embodiments of the present disclosure;

FIG. 25 is a longitudinal cross-sectional view of an edge coupler in an optical module according to some embodiments of the present disclosure;

FIG. 26 is a schematic diagram of an internal structure of an optical chip according to some embodiments of the present disclosure;

FIG. 27 is a first perspective structural diagram of an optical coupler according to some embodiments of the present disclosure;

FIG. 28 is a first cross-sectional structural diagram of an optical coupler according to some embodiments of the present disclosure;

FIG. 29 is a second perspective structural diagram of an optical coupler according to some embodiments of the present disclosure;

FIG. 30 is a second cross-sectional structural diagram of an optical coupler according to some embodiments of the present disclosure;

FIG. 31 is an assembly diagram between a transmission waveguide and a transition waveguide according to some embodiments of the present disclosure;

FIG. 32 is an assembly diagram between a transition waveguide and a coupling waveguide array according to some embodiments of the present disclosure;

FIG. 33 is a schematic structural diagram of an optical chip according to some embodiments of the present disclosure;

FIG. 34 is a first schematic structural diagram of a polarization rotator-splitter according to some embodiments of the present disclosure;

FIG. 35 is a cross-sectional view in an A-A direction in FIG. 34;

FIG. 36 is a first partial enlarged view of a polarization rotator-splitter according to some embodiments of the present disclosure;

FIG. 37 is a second partial enlarged view of a polarization rotator-splitter according to some embodiments of the present disclosure;

FIG. 38 is a third partial enlarged view of a polarization rotator-splitter according to some embodiments of the present disclosure;

FIG. 39 is a fourth partial enlarged view of a polarization rotator-splitter according to some embodiments of the present disclosure;

FIG. 40 is a second schematic structural diagram of a polarization rotator-splitter according to some embodiments of the present disclosure;

FIG. 41 is a cross-sectional view in a B-B direction in FIG. 36;

FIG. 42 is a cross-sectional view in a C-C direction in FIG. 36;

FIG. 43 is a schematic structural diagram of a mode conversion portion according to some embodiments of the present disclosure;

FIG. 44 is a cross-sectional view in a D-D direction of FIG. 37;

FIG. 45 is a cross-sectional view in an E-E direction of FIG. 37;

FIG. 46 is a cross-sectional view in an F-F direction of FIG. 38;

FIG. 47 is a partial enlarged view of a polarization rotator-splitter according to some embodiments of the present disclosure;

FIG. 48 is a structural diagram of another mode coupling portion according to some embodiments of the present disclosure;

FIG. 49 is a structural diagram of another mode coupling portion according to some embodiments of the present disclosure; and

FIG. 50 is a cross-sectional view in a G-G direction of FIG. 39.

### DETAILED DESCRIPTION OF THE EMBODIMENTS

The technical solutions in some embodiments of the present disclosure will be clearly and detailedly described below with reference to the accompanying drawings. Apparently, the described embodiments are merely some rather than all of the embodiments of the present disclosure. All other embodiments obtained by those of ordinary skill in the art based on the embodiments provided in the present disclosure fall within the scope of protection of the present disclosure.

In optical communication technology, in order to establish information transmission between information processing devices, it is necessary to load information onto light and use the propagation of light to implement the transmission of information. Here, the light loaded with information is an optical signal. When the optical signal is transmitted in the information transmission devices, the loss of optical power can be reduced, such that high-speed, long-distance, and low-cost information transmission can be implemented. The signals that the information processing devices are able to recognize and process are electrical signals. The information processing devices usually include optical network units (ONUs), gateways, routers, switches, mobile phones, computers, servers, tablet computers, televisions, etc. The information transmission devices usually include optical fibers and optical waveguides.

The optical modules enable the conversion between optical signals and electrical signals from the information processing devices and the information transmission devices. For example, at least one of an optical signal input or an optical signal output of an optical module is connected to an optical fiber, and at least one of an electrical signal input or an electrical signal output of the optical module is connected to an optical network unit; a first optical signal from the optical fiber is transmitted to the optical module, and the optical module converts the first optical signal into a first electrical signal and transmits the first electrical signal to the optical network unit; and a second electrical signal from the optical network unit is transmitted to the optical module, and the optical module converts the second electrical signal into a second optical signal and transmits the second optical signal to the optical fiber. Since information can be transmitted through electrical signals between a plurality of information processing devices, at least one information processing device in the plurality of information processing devices is required to be directly connected to the optical module, and all information processing devices are not required to be directly connected to the optical module. Here, the information processing device directly connected to the optical module is referred to as a host computer of the optical module. In addition, the optical signal input or the optical signal output of the optical module can be referred to as an optical port, and the electrical signal input or the electrical signal output of the optical module can be referred to as an electrical port.

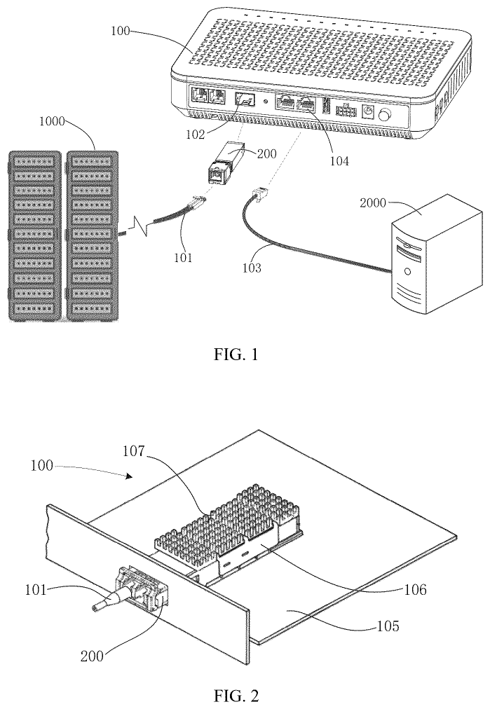

FIG. 1 is a partial structural diagram of an optical communication system according to some embodiments of the present disclosure. As shown in FIG. 1, the optical communication system primarily includes a remote information processing device 1000, a local information processing device 2000, a host computer 100, an optical module 200, an optical fiber 101 and a network cable 103.

One end of the optical fiber 101 extends toward the remote information processing device 1000, and the other end of the optical fiber 101 is connected to the optical module 200 via an optical port of the optical module 200. An optical signal can undergo total reflection in the optical fiber 101, and the propagation of the optical signal in a total reflection direction can almost maintain its original optical power. The optical signal undergoes multiple total reflections in the optical fiber 101 to transmit an optical signal from the remote information processing device 1000 to the optical module 200 or to transmit an optical signal from the optical module 200 to the remote information processing device 1000, thereby implementing long-distance and low-power-loss information transmission.

The optical communication system may include one or more optical fibers 101, and the optical fiber 101 is detachably or fixedly connected to the optical module 200. The host computer 100 is configured to provide a data signal to the optical module 200, receive a data signal from the optical module 200, or monitor or control a working state of the optical module 200.

The host computer 100 includes a generally cuboid-shaped housing, and an optical module interface 102 arranged on the housing. The optical module interface 102 is configured to be connected to the optical module 200, enabling the host computer 100 to establish a one-way or two-way electrical signal connection with the optical module 200.

The host computer 100 further includes an external electrical interface that can be connected to an electrical signal network. For example, the external electrical interface includes a universal serial bus (USB) interface or a network cable interface 104. The network cable interface 104 is configured to be connected to the network cable 103, enabling the host computer 100 to establish a one-way or two-way electrical signal connection with the network cable 103. One end of the network cable 103 is connected to the local information processing device 2000, and the other end of the network cable 103 is connected to the host computer 100, thereby establishing an electrical signal connection between the local information processing device 2000 and the host computer 100 via the network cable 103. For example, a third electrical signal sent by the local information processing device 2000 is transmitted to the host computer 100 via the network cable 103. The host computer 100 generates a second electrical signal according to the third electrical signal. The second electrical signal from the host computer 100 is transmitted to the optical module 200. The optical module 200 converts the second electrical signal into a second optical signal and transmits the second optical signal to the optical fiber 101. The second optical signal is transmitted through the optical fiber 101 to the remote information processing device 1000. For example, a first optical signal from the remote information processing device 1000 is transmitted through the optical fiber 101. The first optical signal from the optical fiber 101 is transmitted to the optical module 200. The optical module 200 converts the first optical signal into a first electrical signal, and then the optical module 200 transmits the first electrical signal to the host computer 100. The host computer 100 generates a fourth electrical signal according to the first electrical signal and transmits the fourth electrical signal to the local information processing device 2000. It should be noted that the optical module is a tool to implement the conversion between optical signals and electrical signals. In the conversion between the optical signals and the electrical signals, the information remains unchanged, and the encoding and decoding methods for the information may vary.

In addition to the optical network unit, the host computer 100 further includes an optical line terminal (OLT), an optical network terminal (ONT), or a data center server.

FIG. 2 is a partial structural diagram of a host computer according to some embodiments of the present disclosure. To clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105 arranged in the housing, a cage 106 arranged on the surface of the PCB 105, a heat sink 107 arranged on the cage 106, and an electrical connector arranged inside the cage 106. The electrical connector is configured to be connected to the electrical port of the optical module 200. The heat sink 107 has protruding structures such as fins that enlarge the heat dissipation area.

The optical module 200 is inserted into the cage 106 of the host computer 100, and the optical module 200 is fixed by the cage 106. Heat generated by the optical module 200 is conducted to the cage 106 and then diffused through the heat sink 107. After the optical module 200 is inserted into the cage 106, the electrical port of the optical module 200 is connected to the electrical connector inside the cage 106, such that the optical module 200 establishes a two-way electrical signal connection with the host computer 100. In addition, the optical port of the optical module 200 is connected to the optical fiber 101, thereby establishing a bidirectional optical signal connection between the optical module 200 and the optical fiber 101.

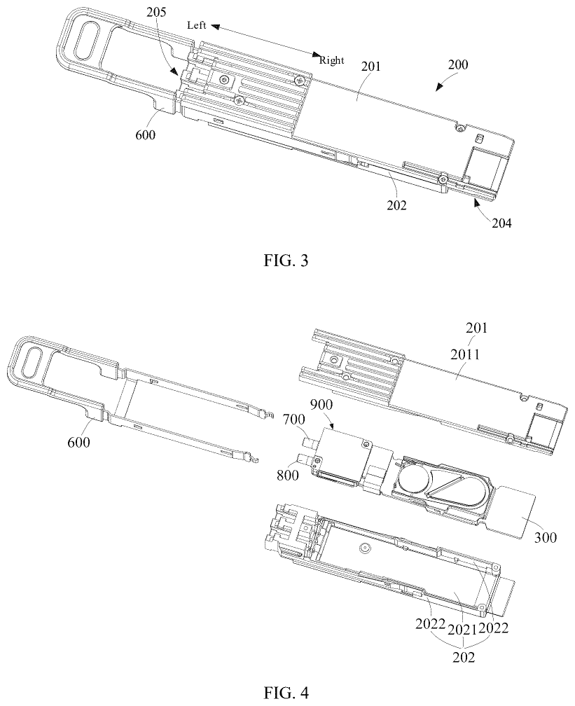

FIG. 3 is a structural diagram of an optical module according to some embodiments of the present disclosure. FIG. 4 is an exploded view of an optical module according to some embodiments of the present disclosure. As shown in FIG. 3 and FIG. 4, the optical module 200 includes a housing, and a circuit board 300, a light source 900, an optical chip, a transmitting optical fiber adapter 700, and a receiving optical fiber adapter 800 which are provided in the housing, but the present disclosure is not limited thereto.

The housing includes an upper housing 201 and a lower housing 202, where the upper housing 201 covers the lower housing 202 to form the housing with an opening 204 and an opening 205; and the outer contour of the housing is generally square.

In some embodiments, the lower housing 202 includes a bottom plate 2021 and two lower side plates 2022 located at two sides of the bottom plate 2021 and perpendicular to the bottom plate 2021; and the upper housing 201 includes a cover plate 2011, where the cover plate 2011 covers the two lower side plates 2022 of the lower housing 202 to form the housing.

In some embodiments, the lower housing 202 includes a bottom plate 2021 and two lower side plates 2022 located at two sides of the base plate 2021 and perpendicular to the bottom plate 2021; and the upper housing 201 includes a cover plate 2011 and two upper side plates located at two sides of the cover plate 2011 and perpendicular to the cover plate 2011, where the two upper side plates and the two lower side plates 2022 are combined to ensure that the upper housing 201 covers the lower housing 202.

The direction of a connecting line between the opening 204 and the opening 205 may be consistent with the length direction of the optical module 200 or may be inconsistent with the length direction of the optical module 200. For example, the opening 204 is located at the end of the optical module 200 (the right end of FIG. 3), and the opening 205 is also located at the end of the optical module 200 (the left end of FIG. 3). Alternatively, the opening 204 is located at the end of the optical module 200, and the opening 205 is located at the side of the optical module 200. The opening 204 is an electrical port, where a gold finger of the circuit board 300 extends out from the electrical port and is inserted into the electrical connector of the host computer 100. The opening 205 is an optical port, which is configured to be connected to the external optical fiber 101 such that the optical fiber 101 is connected to the optical transceiver component 900 in the optical module 200.

An assembly method of combining the upper housing 201 with the lower housing 202 is adopted, such that the circuit board 300, the light source 900, the optical chip, the transmitting optical fiber adapter 700, the receiving optical fiber adapter 800, and other components can be conveniently mounted in the housing, and these components can be packaged by the upper housing 201 and lower housing 202 for protection. In addition, when the circuit board 300, the light source 900, the optical chip, the transmitting optical fiber adapter 700, the receiving optical fiber adapter 800, and other components are assembled, the assembly method of combining the upper housing 201 with the lower housing 202 facilitates the deployment of positioning components, heat dissipation components, and electromagnetic shielding components for these components, which is conducive to automated production.

In some embodiments, the upper housing 201 and the lower housing 202 are made of metal materials, facilitating electromagnetic shielding and heat dissipation.

In some embodiments, the optical module 200 further includes an unlocking component 600 located outside its housing. The unlocking component 600 is configured to implement a fixed connection between the optical module 200 and the host computer 100, or to release the fixed connection between the optical module 200 and the host computer 100.

For example, the unlocking component 600 is located outside the two lower side plates 2022 of the lower housing 202, and includes an engaging component that matches the cage 106 of the host computer 100. When the optical module 200 is inserted into the cage 106, the optical module 200 is fixed in the cage 106 by the engaging component of the unlocking component 600; and when the unlocking component 600 is pulled, the engaging component of the unlocking component 600 moves accordingly, such that the connection relationship between the engaging component and the host computer is changed to release the fixation of the optical module 200 to the host computer, thereby pulling out the optical module 200 from the cage 106.

The circuit board 300 includes circuit traces, electronic components, and chips, where the electronic components and the chips are connected according to the circuit design through the circuit traces to implement the functions such as power supply, electrical signal transmission and grounding. The electronic components may include, for example, capacitors, resistors, transistors, and metal-oxide-semiconductor field-effect transistors (MOSFETs). The chips may include, for example, microcontroller units (MCUs), laser driving chips, transimpedance amplifiers (TIAs), limiting amplifiers (LIAs), clock and data recovery (CDR) chips, power management chips, and digital signal processing (DSP) chips.

The circuit board 300 is generally a rigid circuit board. The rigid circuit board can also achieve the bearing effect because of its relatively hard material, for example, the rigid circuit board can smoothly carry the above-mentioned electronic components and chips. The rigid circuit board can also be inserted into the electrical connector in the cage 106 of the host computer 100.

The circuit board 300 further includes a gold finger formed on its end surface, where the gold finger consists of a plurality of pins that are independent of each other. The circuit board 300 is inserted into the cage 106, and the gold finger is electrically connected to the electrical connector in the cage 106. The gold finger may be provided only on a side surface of the circuit board 300 (such as an upper surface shown in FIG. 4), or may be provided on upper and lower side surfaces of the circuit board 300 to provide more pins, so as to adapt to occasions requiring a large number of pins. The gold finger is configured to establish an electrical connection with the host computer to implement power supply, grounding, two-wire inter-integrated circuit (I2C) signal transmission, data signal transmission, and the like. Certainly, flexible circuit boards are also used in some optical modules. Flexible circuit boards are generally used in conjunction with rigid circuit boards as a supplement to rigid circuit boards.

In some embodiments, the light source 900, the optical chip, and the circuit board 300 are physically separated, and then electrically connected to the circuit board 300 via flexible circuit boards or electrical connectors.

In some embodiments, the light source 900 and the optical chip may be directly provided on the circuit board 300. For example, the light source 900 and the coherent optical chip may be provided on a surface of the circuit board 300 or a side of the circuit board 300.

In some embodiments, the optical chip may be a coherent optical chip 1100, but is not specifically limited.

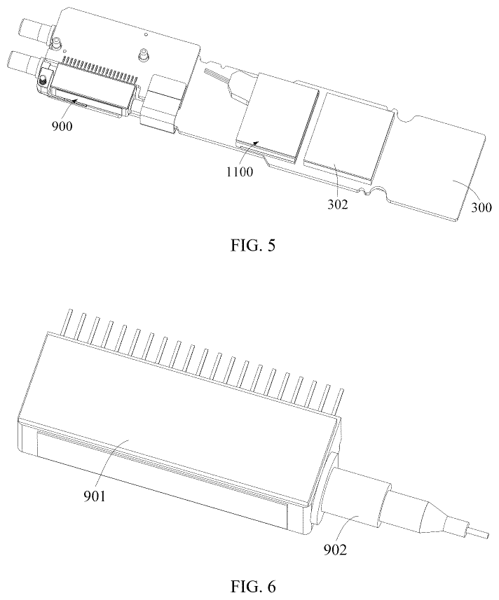

FIG. 5 is a partial structural diagram of an optical module provided according to some embodiments of the present disclosure. As shown in FIG. 5, the light source 900 is electrically connected to the circuit board 300, and the light source 900 is used to emit a beam with a specific wavelength. The light source 900 may include a semiconductor gain chip and a wavelength tuning chip. The semiconductor gain chip emits a beam in a wavelength range, and the wavelength tuning chip selects the beam with a specific wavelength from the beam in a wavelength range. The wavelength tuning chip and the semiconductor gain chip form a resonant cavity, and the beam with a specific wavelength is reflected back and forth between the wavelength tuning chip and the semiconductor gain chip, such that the beam with a specific wavelength is stably output by the semiconductor gain chip.

The coherent optical chip 1100 is mounted on the circuit board 300, and the coherent optical chip 1100 is configured to implement high-speed optoelectronic signal conversion, that is, the coherent optical chip includes an optical transmitting interface, an optical receiving interface, and a local oscillator optical interface. The optical transmitting interface extends out of a first optical fiber, the optical receiving interface extends out of a second optical fiber, and the local oscillator optical interface extends out of a third optical fiber. The optical transmitting interface is connected to the transmitting optical fiber adapter 700 via the first optical fiber, the optical receiving interface is connected to the receiving optical fiber adapter 800 via the second optical fiber, the local oscillator optical interface is connected to the light source 900 via the third optical fiber, and the coherent optical chip 1100 is also connected to the DSP chip 302.

The narrow linewidth and high-power laser emitted by the light source 900 is input into the coherent optical chip 1100 through the local oscillator optical interface. The laser is subjected to beam splitting inside the coherent optical chip 1100, and one beam is used as a transmitting beam and enters a coherent modulator inside the coherent optical chip. Under the drive of the high-speed electrical signal of the DSP chip 302, optoelectronic signal conversion is implemented, the converted high-speed optical signal is output from the optical transmitting interface, and transmitted to the transmitting optical fiber adapter 700 via the first optical fiber, thereby implementing emission of coherent light.

The other beam is used as a local oscillator beam. The high-speed optical signal transmitted by the receiving optical fiber adapter 800 is input into the coherent optical chip 1100 from the optical receiving interface. The local oscillator beam and the high-speed optical signal are coherently demodulated, and the demodulated electrical signal enters the DSP chip 302 for signal processing, thereby implementing the reception of coherent light.

In some embodiments, the narrow linewidth and high-power laser emitted by the light source 900 is a laser with a specific wavelength.

The optical module provided by the embodiments of the present disclosure may include a circuit board, a light source, an optical chip, an optical fiber, and a coupler assembly.

In some embodiments, the light source includes a laser assembly, the laser assembly is electrically connected to the circuit board, the laser assembly includes a semiconductor gain chip and a wavelength tuning chip, the semiconductor gain chip is configured to emit a beam in a wavelength range, and the wavelength tuning chip and the semiconductor gain chip form a resonant cavity; the wavelength tuning chip includes: an input coupler, configured to receive the beam emitted by the semiconductor gain chip and transmit the beam with a specific wavelength to the semiconductor gain chip; a power splitter, connected to the input coupler, where the power splitter is configured to split the beam input from the input coupler; and at least one microring filter, connected to an output end of the power splitter, where the microring filter is configured to filter out the beam with a specific wavelength from the beams in the wavelength range;
the microring filter includes a silicon waveguide ridge region, a first slab region, and a second slab region; the silicon waveguide ridge region is configured to transmit the beams and generate electron hole pairs during the transmission of the beams; the first slab region is located on one side of the silicon waveguide ridge region, and an N-type doped region is provided in the first slab region; and the second slab region is located on the other side of the silicon waveguide ridge region, a P-type doped region is provided in the second slab region, the P-type doped region and the N-type doped region form a PN junction, and the PN junction is configured to absorb the electron hole pairs in the silicon waveguide ridge region, the first slab region, and the second slab region.

The structure of the laser assembly can solve the problem of nonlinear effect of a silicon photonic resonator as a laser resonant cavity under high optical power, thereby implementing a laser with high optical power, narrow linewidth and wide tunability. The specific structure of the laser assembly may be understood with reference to the following descriptions.

In some embodiments, the optical chip is electrically connected to the circuit board, and the optical chip is configured to receive an external optical signal; the optical fiber is configured to transmit an external optical signal; the coupler assembly is coupled to the optical fiber, and the coupler assembly is configured to couple the external optical signal transmitted by the optical fiber to the optical chip; the coupler assembly includes: a first coupling waveguide, where one end of the first coupling waveguide is coupled to the optical fiber, and the first coupling waveguide is configured to receive the external optical signal transmitted by the optical fiber; a second coupling waveguide, where the second coupling waveguide is configured to couple the external optical signal to the optical chip; and at least one transition waveguide, provided between the first coupling waveguide and the second coupling waveguide, where the at least one transition waveguide is configured to couple the external optical signal transmitted by the first coupling waveguide to the second coupling waveguide.

The optical chip and the coupler assembly provided between the optical chip and the optical fiber can solve the defect of large coupling loss between a silicon-based optical waveguide and a single-mode optical fiber, thereby implementing ultra-low coupling insertion loss between the silicon-based optical waveguide and the single-mode optical fiber. The specific structure of the coupler assembly may be understood with reference to the following descriptions.

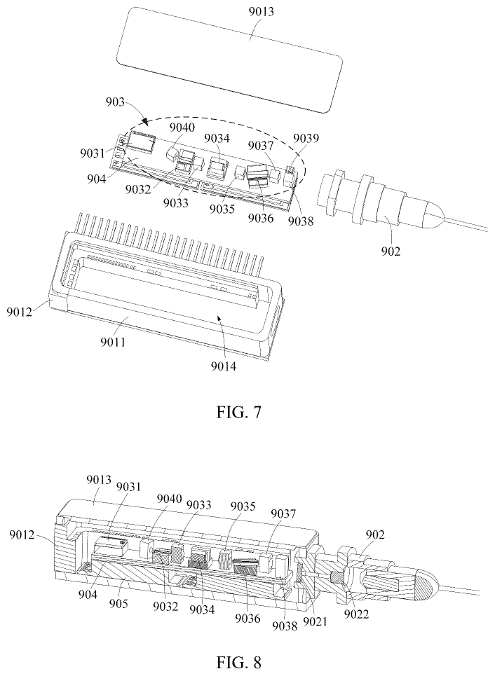

FIG. 6 is a structural diagram of a light source assembly in an optical module according to some embodiments of the present disclosure. FIG. 7 is an exploded view of a light source assembly in an optical module according to some embodiments of the present disclosure. As shown in FIG. 6 and FIG. 7, the light source 900 includes a laser assembly 901 and an internal optical fiber adapter 902. The laser assembly 901 is configured to generate laser light with a specific wavelength, and the internal optical fiber adapter 902 is connected to the local oscillator optical interface of the coherent optical chip 1100 via a local oscillator optical fiber (namely, the third optical fiber mentioned in the above examples), such that the laser light generated by the laser assembly 901 is input to the coherent optical chip 1100 through the internal optical fiber adapter 902 and the local oscillator optical fiber.

The laser assembly 901 includes a tube housing 9011, an electrical connector 9012, and a cover plate 9013. The tube housing 9011 includes a bottom plate, a first side plate, a second side plate, a third side plate, and a fourth side plate. The first side plate, the second side plate, the third side plate, and the fourth side plate are connected to the bottom plate. The first side plate and the second side plate are arranged opposite each other, the third side plate and the fourth side plate are arranged opposite each other, so the bottom plate, the first side plate, the second side plate, the third side plate, and the fourth side plate form a housing with an opening at the top.

The third side plate faces the transmitting optical fiber adapter 700, the fourth side plate faces the coherent optical chip 1100, an open slot is formed in the third side plate, and a mounting slot is formed in the fourth side plate. The open slot and the mounting slot are interconnected, such that the open slot and the mounting slot form an L-shaped slot. The electrical connector 9012 has an L-shaped structure, and the electrical connector 9012 is inserted into the L-shaped slot of the tube housing 9011 to implement connection between the electrical connector 9012 and the tube housing 9011.

A plurality of metal pins are formed on a side surface of the electrical connector 9012 located outside the tube housing 9011, and the plurality of metal pins are soldered to pin pads on the circuit board 300 to implement electrical connection between the electrical connector 9012 and the circuit board 300; and the solder pads are formed on the side surface of the electrical connector 9012 located inside the tube housing 9011.

In some embodiments, a through hole is formed in the fourth side plate, and one end of the internal optical fiber adapter 902 is inserted into the through hole to implement assembly of the internal optical fiber adapter 902 and the tube housing 9011.

An accommodating cavity 9014 is formed in the tube housing 9011, and an optical assembly 903 is mounted within the accommodating cavity 9014. The optical assembly 903 is electrically connected to pads on the electrical connector 9012, such that the optical assembly 903 generates a beam with a specific wavelength; the beam with a specific wavelength generated by the optical assembly 903 is transmitted to the local oscillator optical fiber via the internal optical fiber adapter 902, and then enters the coherent optical chip 1100 via the local oscillator optical fiber.

In some embodiments, the optical assembly 903 comprises a wavelength tuning chip 9031, a semiconductor gain chip 9032, a first lens 9033, an isolator 9034, a second lens 9035, a semiconductor amplifier chip 9036, a third lens 9037, abeam splitter 9038, a power monitor 9039, and a fourth lens 9040, where the semiconductor gain chip 9032 is located between the electrical connector 9012 and the internal optical fiber adapter 902, and the semiconductor gain chip 9032 is configured to emit the beam in a wavelength range.

The wavelength tuning chip 9031 is located between the electrical connector 9012 and the semiconductor gain chip 9032. The wavelength tuning chip 9031 is electrically connected to the pads on the electrical connector 9012 via wire bonding. The wavelength tuning chip 9031 is configured to receive the beam in a wavelength range and select the beam with a specific wavelength from the beam in a wavelength range; and the wavelength tuning chip 9031 is further configured to allow the beam with a specific wavelength to enter the semiconductor gain chip 9032. The wavelength tuning chip 9031 and the semiconductor gain chip 9032 form a resonant cavity, where the beam with a specific wavelength is reflected back and forth between the wavelength tuning chip 9031 and the semiconductor gain chip 9032, enabling the stable output of the beam with a specific wavelength by the semiconductor gain chip. In some embodiments, the wavelength tuning chip 9031 may be a silicon photonic chip.

In some embodiments, the semiconductor gain chip 9032 is made of an III-V group gain material and includes two optical waveguide end faces. One end face thereof is of an inclined waveguide structure, is coated with an anti-reflection film to implement extremely low optical field reflectivity, and is configured to couple with the input coupler of the wavelength tuning chip 9031, thereby facilitating the back-and-forth reflection of the beam with a specific wavelength between the semiconductor gain chip 9032 and the wavelength tuning chip 9031; and the other end face thereof is of a straight optical waveguide structure and is coated with a reflective film with certain reflectivity to implement optical field reflection and transmission functions, thereby facilitating the emission of the beam with a specific wavelength by the semiconductor gain chip 9032 when the beam with a specific wavelength oscillates to a certain level.

The fourth lens 9040 is located between the wavelength tuning chip 9031 and the semiconductor gain chip 9032. The fourth lens 9040 is configured to collimate the beam in a wavelength range output by the semiconductor gain chip 9032, such that the beam output by the semiconductor gain chip 9032 enters the wavelength tuning chip 9031.

The first lens 9033 is located between the semiconductor gain chip 9032 and the internal optical fiber adapter 902. The first lens 9033 is configured to collimate the beam with a specific wavelength output by the semiconductor gain chip 9032. In some embodiments, the first lens 9033 may be a collimating lens.

The isolator 9034 is located between the first lens 9033 and the internal optical fiber adapter 902. The isolator 9034 is configured to prevent the beam entering the internal optical fiber adapter 902 from reflecting back into the semiconductor gain chip 9032, thereby alleviating impact caused by optical path reflection and further lowering the noise level of the light source 900.

The second lens 9035 is located between the isolator 9034 and the internal optical fiber adapter 902. The second lens 9035 is configured to focus the beam with a specific wavelength passing through the isolator 9034 onto the internal optical fiber adapter 902. In some embodiments, the second lens 9035 may be a converging lens.

The semiconductor amplifier chip 9036 is located between the second lens 9035 and the internal optical fiber adapter 902. The second lens 9035 is configured to focus the beam with a specific wavelength onto the semiconductor amplifier chip 9036, and the semiconductor amplifier chip 9036 is configured to amplify the power of the beam with a specific wavelength to increase the optical power of the beam with a specific wavelength.

The third lens 9037 is located between the semiconductor amplifier chip 9036 and the internal optical fiber adapter 902. The third lens 9037 is configured to collimate the beam with a specific wavelength after power amplification. In some embodiments, the third lens 9037 may be a collimating lens.

The beam splitter 9038 is located between the third lens 9037 and the internal optical fiber adapter 902. The beam splitter 9038 is configured to split the beam with a specific wavelength into two paths, one coupled to the power monitor 9039 and the other coupled into the internal optical fiber adapter 902.

The power monitor 9039 is located between the beam splitter 9038 and a first side plate of the tube housing 9011, where the power monitor 9039 is configured to in real time monitor the optical power of the beam with a specific wavelength. When the optical power of the beam with a specific wavelength is lower than a preset optical power range, the amplification factor of the semiconductor amplifier chip 9036 is increased such that the optical power of the beam with a specific wavelength falls within the preset optical power range; and when the optical power of the beam with a specific wavelength exceeds the preset optical power range, the amplification factor of the semiconductor amplifier chip 9036 is decreased such that the optical power of the beam with a specific wavelength falls within the preset optical power range.

FIG. 8 is a cross-sectional view of a light source assembly in an optical module according to some embodiments of the present disclosure. As shown in FIG. 8, in some embodiments, a semiconductor cooler 905 is also provided in the accommodating cavity 9014. A substrate 904 is mounted on the cooling surface of the semiconductor cooler 905, and the optical assembly 903 is mounted on the substrate 904. The temperature of the wavelength tuning chip 9031 can be controlled by the semiconductor cooler 905 to adjust the wavelength of the beam output by the wavelength tuning chip 9031, such that the wavelength tuning chip 9031 outputs the beam with a specific wavelength.

The internal optical fiber adapter 902 is provided with an optical window 9021 and a fifth lens 9022, where the optical window 9021 is close to the beam splitter 9038. One path of light emitted from the beam splitter 9038 enters the internal optical fiber adapter 902 through the optical window 9021, and is then focused and coupled to an optical fiber ferrule inside the internal optical fiber adapter 902 via the fifth lens 9022, so as to couple the beam with a specific wavelength emitted by the optical assembly 903 into the internal optical fiber adapter 902.

In some embodiments, to enable the optical assembly 903 to generate the beam with a specific wavelength, multiple microring filters are integrated within the wavelength tuning chip 9031, and the wavelength tunability of the wavelength tuning chip 9031 is implemented by utilizing the vernier effect of multiple different microring filters.

FIG. 9 is a schematic diagram of a wavelength tuning chip in an optical module according to some embodiments of the present disclosure. As shown in FIG. 9, an input coupler 906, a phase shifter 907, a power splitter 908, a first microring filter 909, and a second microring filter 910 are formed in the wavelength tuning chip 9031, where the input coupler 906, the phase shifter 907, the power splitter 908, the first microring filter 909, and the second microring filter 910 are all fabricated by the wavelength tuning chip 9031 using a complementary metal oxide semiconductor (CMOS) process.

The input coupler 906 is provided at one side end face of the wavelength tuning chip 9031, where the input coupler 906 is configured to receive the beam in a wavelength range emitted by the semiconductor gain chip 9032, and is also configured to output the beam with a specific wavelength filtered by the wavelength tuning chip 9031 to the outside of the wavelength tuning chip 9031.

The beam with a specific wavelength is reflected back and forth between the wavelength tuning chip 9031 and the semiconductor gain chip 9032, such that the semiconductor gain chip 9032 and the wavelength tuning chip 9031 form a resonant cavity, enabling the stable output of the beam with a specific wavelength by the semiconductor gain chip 9032.

In some embodiments, the input coupler 906 is designed as an inclined waveguide, that is, the optical waveguide of the input coupler 906 is provided at a certain angle with respect to the end face of the wavelength tuning chip 9031. Thus, when the beam emitted by the semiconductor gain chip 9032 enters the input coupler 906 from the upper right, part of the beam may be reflected at the end face of the wavelength tuning chip 9031, and the reflected beam will be emitted from the upper right, rather than returning to the semiconductor gain chip 9032 along an original path, thereby alleviating the impact of the end face reflected light of the wavelength tuning chip 9031 on the semiconductor gain chip 9032.

Since one end face of the semiconductor gain chip 9032 is of an inclined waveguide structure, the inclined waveguide structures of the input coupler 906 and the semiconductor gain chip 9032 are arranged in parallel in an optical path direction, such that the semiconductor gain chip 9032 and the wavelength tuning chip 9031 are matched, and the reflection of the optical field of the input coupler 906 is reduced to improve the quality of the beam.

In some embodiments, the inclined waveguide structures of the input coupler 906 and the semiconductor gain chip 9032 can be arranged in parallel in the optical path direction, such that the angle of emergence of the beam with a specific wavelength output by the input coupler 906 is 20°.

The phase shifter 907 is located between the input coupler 906 and the power splitter 908, where the phase shifter 907 is configured to adjust the wavelength of the beam supported by the resonant cavity, so as to make the beam with a specific wavelength filtered by the first microring filter 909 and the second microring filter 910 coincide with the beam in the resonant cavity.

In some embodiments, a heater is provided on the phase shifter 907. By changing the heater, the cavity length of the phase shifter 907 is changed, thereby changing the cavity length of the resonant cavity. This makes the beam with a certain wavelength supported by the resonant cavity coincide with the beam with a specific wavelength filtered by two microring resonant cavities.

The power splitter 908 is located between the phase shifter and the first microring filter 909, the power splitter 908 is configured to split light, splitting the beam output by the phase shifter 907 into two beams; the power splitter 908 is also configured to combine light, combining the beams with a specific wavelength filtered by the first microring filter 909 and the second microring filter 910.

The power splitter generally refers to a power divider; the power divider is a device that divides the energy of one input signal into two or more outputs with equal or unequal energy, and can also combine the energy of multiple signals into one output, in which case it can also be called a combiner.

The power splitter 908 divides one beam output by the phase shifter 907 into two beams, where one beam passes through the first microring filter 909 and then the second microring filter 910, and the other beam passes through the second microring filter 910 and then the first microring filter 909. The power splitter 908 can also combine the beam with a specific wavelength filtered by the first microring filter 909 and then the second microring filter 910, and the beam with a specific wavelength filtered by the second microring filter 910 and then the first microring filter 909, into one beam with a specific wavelength.

In some embodiments, the splitting ratio of the power splitter 908 can be 50%:50%, that is, the power splitter 908 divides one beam into two beams at a ratio of 50%:50%. After filtered by the first microring filter 909 and the second microring filter 910, these two beams return to the power splitter 908. According to the principle of optical path reversibility, it can be known that, theoretically, except for losses caused by the first microring filter 909, the second microring filter 910, and the optical waveguide, other losses are zero.

The splitting ratio of the power splitter 908 can also be 20%:80%, where the power splitter 908 divides one beam into two beams at a ratio of 20%:80%. After filtered by the first microring filter 909 and the second microring filter 910, these two beams return to the power splitter 908. According to the principle of optical path reversibility, it can be known that, theoretically, except for losses caused by the first microring filter 909, the second microring filter 910, and the optical waveguide, other losses are greater than zero.

In some embodiments, in order to minimize the loss of the beam, the splitting ratio of the power splitter is 50%:50%.

The first microring filter 909 and the second microring filter 910 cooperate to filter out the beam with a specific wavelength from the beam in a wavelength range emitted by the semiconductor gain chip 9032. The first microring filter 909 and the power splitter 908 are coupled via a first straight optical waveguide, the first microring filter 909 and the second microring filter 910 are coupled via a second straight optical waveguide, and the second microring filter 910 and the power splitter 908 are coupled via a third straight optical waveguide.

The first microring filter 909 and the second microring filter 910 are both of microring structures, but have different perimeters. Therefore, the wavelengths of the beams filtered by the first microring filter 909 and the second microring filter 910 are different. Two microring filters of different sizes have different mode wavelength spacings. The refractive index of the resonant cavity is changed using the thermo-optic effect, such that the position of the mode wavelength can be adjusted. Based on the vernier effect, only when the mode wavelengths of the two microring filters coincide, a specific wavelength can be selected, such that the wavelength tuning chip 9031 outputs the beam with a specific wavelength, implementing the wavelength tunability function.

FIG. 10 is a schematic diagram of an operating principle of a wavelength tuning chip in an optical module according to some embodiments of the present disclosure. As shown in FIG. 10, in some embodiments, the principle by which the first microring filter 909 and the second microring filter 910 filter the beam with a specific wavelength is as follows:

The beam in a wavelength range enters from the input end of the first straight optical waveguide (one end close to the power splitter 908). When the beam is transmitted to the first coupling region between the first straight optical waveguide and the first microring filter 909, part of the beam is coupled into the first microring filter 909, and the remaining part of the beam is output from the output end of the first straight optical waveguide (one end away from the power splitter 908). When the beam propagating in the first microring filter 909 passes through a second coupling region formed by the second straight optical waveguide and the first microring filter 909, part of the beam is coupled into the second straight optical waveguide, and the remaining part of the beam continues to propagate in the first microring filter 909. When the beam propagating in the first microring filter 909 satisfies the resonance condition mλ=nl of the first microring filter 909, resonance occurs, resulting in coherent enhancement. The optical power of the beam obtained by the second straight optical waveguide from the first microring filter 909 also increases, while the beam that does not satisfy the resonance condition is output from the output end of the first straight optical waveguide. λ is the wavelength of the beam, l is the perimeter of the first microring filter, n is the effective refractive index of the first microring filter, and m is a positive integer. In other words, only the beam that satisfies the resonance condition of the first microring filter 909 can be filtered out by the first microring filter 909 and coupled into the second straight optical waveguide.

When the beam is transmitted to the third coupling region between the second straight optical waveguide and the second microring filter 910, part of the beam is coupled into the second microring filter 910, and the remaining part of the beam is output from the second output end of the second straight optical waveguide. When the beam propagating in the second microring filter 910 passes through a fourth coupling region formed by the third straight optical waveguide and the second microring filter 910, part of the beam is coupled into the third straight optical waveguide, and the remaining part of the beam continues to propagate in the second microring filter 910. When the beam propagating in the second microring filter 910 satisfies the resonance condition mλ=nl of the second microring filter 910, resonance occurs, resulting in coherent enhancement. The optical power of the beam obtained by the third straight optical waveguide from the second microring filter 910 also increases, while the beam that does not satisfy the resonance condition is output from the second output end of the second straight optical waveguide. λ is the wavelength of the beam, λ is the perimeter of the second microring filter, n is the effective refractive index of the second microring filter, and m is a positive integer. In other words, only the beam that satisfies the resonance condition of the second microring filter 910 can be filtered out by the second microring filter 910 and coupled into the third straight optical waveguide. In this case, the beam received by the third straight optical waveguide is the beam with a specific wavelength.

The above describes a process by which the beam with a specific wavelength is filtered by the first microring filter 909 and then the second microring filter 910. Similarly, the process by which the beam with a specific wavelength is filtered by the second microring filter 910 and then the first microring filter 909 is as follows:

The beam in a wavelength range enters from the input end of the third straight optical waveguide (one end close to the power splitter 908). When the beam is transmitted to the fourth coupling region between the third straight optical waveguide and the second microring filter 910, part of the beam is coupled into the second microring filter 910, and the remaining part of the beam is output from the output end of the third straight optical waveguide (one end away from the power splitter 908). When the beam propagating in the second microring filter 910 passes through the third coupling region formed by the second straight optical waveguide and the second microring filter 910, part of the beam is coupled into the second straight optical waveguide, and the remaining part of the beam continues to propagate in the second microring filter 910. When the beam propagating in the second microring filter 910 satisfies the resonance condition mλ=nl of the second microring filter 910, resonance occurs, resulting in coherent enhancement. The optical power of the beam obtained by the second straight optical waveguide from the second microring filter 910 also increases, while the beam that does not satisfy the resonance condition is output from the output end of the third straight optical waveguide.

When the beam is transmitted to the second coupling region between the second straight optical waveguide and the first microring filter 909, part of the beam is coupled into the first microring filter 909, and the remaining part of the beam is output from the first output end of the second straight optical waveguide. When the beam propagating in the first microring filter 909 passes through the first coupling region formed by the first straight optical waveguide and the first microring filter 909, part of the beam is coupled into the first straight optical waveguide, and the remaining part of the beam continues to propagate in the first microring filter 909. When the beam propagating in the first microring filter 909 satisfies the resonance condition mλ=nl of the first microring filter 909, resonance occurs, resulting in coherent enhancement. The optical power of the beam obtained by the first straight optical waveguide from the first microring filter 909 also increases, while the beam that does not satisfy the resonance condition is output from the second output end of the second straight optical waveguide. In this case, the beam received by the first straight optical waveguide is the beam with a specific wavelength.

In some embodiments, the first microring filter 909 and the second microring filter 910 are both of microring structures, but have different perimeters. According to the resonance condition, the wavelengths of the beams filtered by the first microring filter 909 and the second microring filter 910 are different. Based on the vernier effect, only when the beam filtered by the first microring filter 909 coincides with the beam filtered by the second microring filter 910, the beam filtered by the wavelength tuning chip 9031 is the beam with a specific wavelength.

The first microring filter 909 and the second microring filter 910 may be of a strip waveguide or ridge waveguide structure. By adjusting the perimeters of the two microring filters, the requirements for different wavelength tuning ranges can be satisfied. Typically, a heater is integrated above the microring filter, and the refractive index of the microring filter is changed via the heater, thereby enabling tuning of different operating wavelengths.

The first microring filter 909 and the second microring filter 910 can filter out the beams with a specific wavelength from the beam in a wavelength range emitted by the semiconductor gain chip 9032. The value of this wavelength is determined by the characteristics of the first microring filter 909 and the second microring filter 910 themselves. However, the resonant cavity formed by the semiconductor gain chip 9032 and the wavelength tuning chip 9031 will select and support multiple beams with different wavelengths according to its own cavity structure, and the beams with multiple wavelengths supported by the resonant cavity do not necessarily coincide with the beams filtered by the two microring filters. If the beams with multiple wavelengths supported by the resonant cavity do not coincide with the beams with specific wavelengths filtered by the two microring filters, the refractive index of the phase shifter 907 can be changed to adjust the cavity length of the phase shifter 907, thereby changing the cavity length of the resonant cavity. This makes the beam with a certain wavelength supported by the resonant cavity coincide with the beam with a specific wavelength, enabling the resonant cavity to emit the beam with a specific wavelength.

However, since the first microring filter 909 and the second microring filter 910 are silicon microrings, silicon material possesses a large third-order nonlinear optical susceptibility. The silicon waveguides inside them may result in excessively high optical power density due to their inherent high refractive index contrast and small cross-sectional size, thus leading to the two-photon absorption (TPA) effect inside the microring filter. Especially when the silicon microring filter is used as a laser resonant cavity, the internal optical power is very high, making the two-photon absorption effect particularly significant. The two-photon absorption effect generates a large number of electron hole pairs (free carriers), and heat is generated during absorption of the free carriers, which in turn changes the refractive index of the resonant cavity. This consequently causes unstable oscillation phenomena in the output wavelength of the laser assembly 901, and limits its application in practical scenarios.

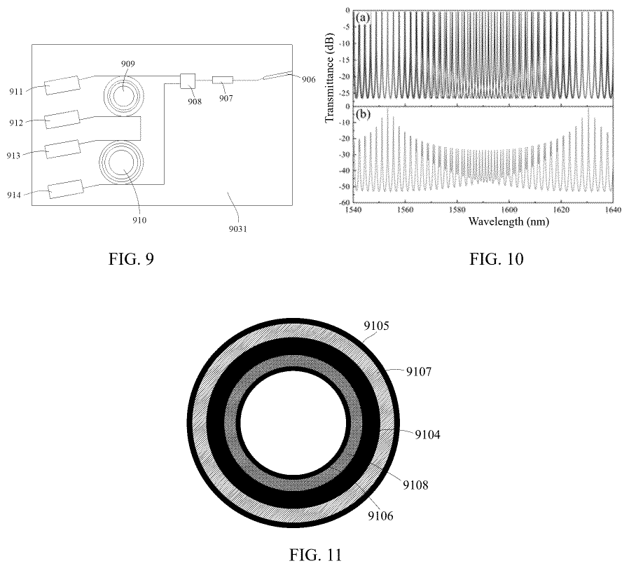

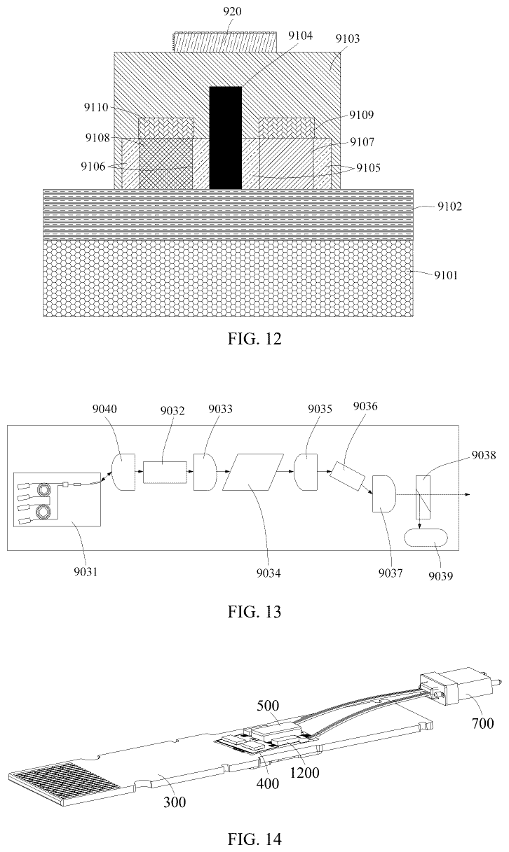

FIG. 11 is a structural diagram of a microring filter in an optical module according to some embodiments of the present disclosure. FIG. 12 is a cross-sectional view of a microring filter in an optical module according to some embodiments of the present disclosure. As shown in FIG. 11 and FIG. 12, in order to address the nonlinear effect issues of silicon microring filter serving as laser resonant cavities under high optical power, the microring filter is of a ridge waveguide structure. Ion implantation is performed in the slab regions on both sides of the waveguide to form a PN junction, and a reverse bias is applied to the PN junction to form an electric field. The PN junction can rapidly absorb electron hole pairs generated by the two-photon absorption effect, thereby eliminating the wavelength oscillation phenomenon of the laser assembly 901.

The first microring filter 909 and the second microring filter 910 have a same structure, but the perimeters of the first microring filter 909 and the second microring filter 910 are different. By adjusting the perimeter of the two microring filters, the requirements for different wavelength tuning ranges can be satisfied.

Referring to FIG. 11, the first microring filter 909 is a ring-shaped filter. In a transverse cross-section of the ring-shaped filter, the ring-shaped filter includes a silicon waveguide ridge region 9104, a first slab region 9105, a second slab region 9106, and contact electrodes. The first slab region 9105 is located on an outer side of the silicon waveguide ridge region 9104 and surrounds the silicon waveguide ridge region 9104; and the second slab region 9106 is located on an inner side of the silicon waveguide ridge region 9104, and the silicon waveguide ridge region 9104 surrounds the second slab region 9106. Thus, from inside to outside, the second slab region 9106, the silicon waveguide ridge region 9104, and the first slab region 9105 are sequentially arranged.

An N-type doped region 9107 is provided within the first slab region 9105, and the N-type doped region 9107 surrounds the silicon waveguide ridge region 9104; a P-type doped region 9108 is provided within the second slab region 9106, and the silicon waveguide ridge region 9104 surrounds the P-type doped region 9108, such that the N-type doped region 9107 and the P-type doped region 9108 enclose the silicon waveguide ridge region 9104.

The N-type doped region 9107 and the P-type doped region 9108 are electrically connected to the contact electrodes, such that power can be supplied to the N-type doped region 9107 and the P-type doped region 9108 via the contact electrodes, causing the N-type doped region 9107 and the P-type doped region 9108 to form the PN junction. The electric field formed by the PN junction surrounds the silicon waveguide ridge region 9104, allowing the PN junction to absorb electron hole pairs within the silicon waveguide ridge region 9104, the first slab region 9105, and the second slab region 9106, thereby preventing heat generation by the electron hole pair load from affecting the refractive index of the resonant cavity, and eliminating the wavelength oscillation phenomenon caused by the two-photon absorption effect.

Referring to FIG. 12, the first microring filter 909 is the ring-shaped filter. In a longitudinal cross-section of the first microring filter 909, the first microring filter 909 includes a silicon substrate 9101, a cladding layer 9103, the silicon waveguide ridge region 9104, the first slab region 9105, and the second slab region 9106. The cladding layer 9103 is provided above the silicon substrate 9101 along an epitaxial growth direction. The silicon substrate 9101 may be made of the silicon material, and the cladding layer 9103 is made of silicon dioxide material, and formed by depositing a thin film made of the silicon dioxide material.

The silicon waveguide ridge region 9104 is located within the cladding layer 9103 and is configured to transmit the beam coupled into the first microring filter 909. Since the silicon waveguide ridge region 9104 transmits the beam by absorbing photons, the optical power of the beam transmitted by the silicon waveguide ridge region 9104 is relatively high, resulting in a large number of electron hole pairs within the silicon waveguide ridge region 9104 as well as the first slab region 9105 and the second slab region 9106 on both sides of the silicon waveguide ridge region 9104.

The first slab region 9105 is located on one side of the silicon waveguide ridge region 9104, and one side of the first slab region 9105 is connected to one side edge of the silicon waveguide ridge region 9104. An N-type doped region 9107 is provided within the first slab region 9105, that is, N-type ions are implanted into the first slab region 9105 to form the N-type doped region 9107 within the first slab region 9105.

The second slab region 9106 is located on the other side of the silicon waveguide ridge region 9104, and one side of the second slab region 9106 is connected to the other side edge of the silicon waveguide ridge region 9104. A P-type doped region 9108 is provided within the second slab region 9106, that is, P-type ions are implanted into the second slab region 9106 to form the P-type doped region 9108 within the second slab region 9106. The P-type doped region 9108 and the N-type doped region 9107 can form the PN junction.

The N-type doped region 9107 within the first slab region 9105 and the P-type doped region 9108 within the second slab region 9106 form the PN junction. The PN junction surrounds the silicon waveguide ridge region 9104 and the portions of the first slab region 9105 and the second slab region 9106 connected to the silicon waveguide ridge region 9104, such that the electric field formed by the PN junction passes through the silicon waveguide ridge region 9104, enabling the PN junction to absorb electron hole pairs within the silicon waveguide ridge region 9104, the first slab region 9105, and the second slab region 9106.

In some embodiments, a first preset distance is provided between the N-type doped region 9107 and the edge of the silicon waveguide ridge region 9104 facing the first slab region 9105 (the right edge as shown in FIG. 12), and a second preset distance is provided between the P-type doped region 9108 and the edge of the silicon waveguide ridge region 9104 facing the second slab region 9106 (the left edge as shown in FIG. 12). The first preset distance and the second preset distance may be equal, such that the first slab region 9105 and the second slab region 9106 are symmetrically arranged on both sides of the silicon waveguide ridge region 9104.

In some embodiments, the first preset distance and the second preset distance range from 500 nm to 1 μm.

In some embodiments, the first preset distance and the second preset distance are 0.8 μm, such that the electric field formed by the PN junction can rapidly absorb electron hole pairs generated by the two-photon absorption effect.

In some embodiments, to apply voltage to the PN junction, the first microring filter 909 further includes contact electrodes. Power is supplied to the PN junction via the contact electrodes; the contact electrodes include a first contact electrode 9109 and a second contact electrode 9110 that are both located within the cladding layer 9103. Along the epitaxial growth direction, the first contact electrode 9109 is provided above the first slab region 9105 and is close to the N-type doped region 9107, facilitating power supply to the N-type doped region 9107 via the first contact electrode 9109.

Along the epitaxial growth direction, the second contact electrode 9110 is provided above the second slab region 9106 and is close to the P-type doped region 9108, facilitating power supply to the P-type doped region 9108 via the second contact electrode 9110.

In some embodiments, the width of the first slab region 9105 may be the same as that of the second slab region 9106, and the width of the first slab region 9105 is greater than that of the silicon waveguide ridge region 9104. The width of the N-type doped region 9107 is less than that of the first slab region 9105, and the width of the P-type doped region 9108 is less than that of the second slab region 9106. The width of the N-type doped region 9107 is the same as that of the P-type doped region 9108. The width of the first contact electrode 9109 may be equal to or slightly greater than that of the N-type doped region 9107, and the width of the second contact electrode 9110 may be equal to or slightly greater than that of the P-type doped region 9108.

The first contact electrode 9109 may be electrically connected to the power supply chip on the circuit board 300 via wire bonding, such that the first contact electrode 9109 is connected to a first voltage. The second contact electrode 9110 may be electrically connected to the power supply chip on the circuit board 300 via wire bonding, such that the second contact electrode 9110 is connected to a second voltage. The first voltage is greater than the second voltage, that is, the first contact electrode 9109 is connected to a high voltage, and the second contact electrode 9110 is connected to a low voltage, such that a reverse bias is applied to the PN junction. The PN junction generates an electric field under reverse bias, enabling the PN junction to rapidly absorb electron hole pairs generated by the two-photon absorption effect.

If a forward bias is applied to the PN junction via the first contact electrode 9109 and the second contact electrode 9110, the electric field formed by the PN junction will be strong, absorbing photons transmitted within the silicon waveguide ridge region 9104, which in turn causes the first microring filter 909 not to output the beam with a specific wavelength.

In some embodiments, the first slab region 9105 and the second slab region 9106 are slab waveguides, which can reduce the transmission loss of the waveguide. Since silicon possesses a large nonlinear optical susceptibility, and the silicon waveguide itself has a high refractive index contrast and small cross-sectional size, it may result in excessively high power density, causing a strong two-photon absorption effect and free carrier absorption effect. The first slab region 9105 and the second slab region 9106 are respectively provided on both sides of the silicon waveguide ridge region 9104. The N-type doped region 9107 is provided within the first slab region 9105, and the P-type doped region 9108 is provided within the second slab region 9106. The P-type doped region 9108 and the N-type doped region 9107 are electrically connected to form the PN junction, and the reverse bias is applied to the PN junction to form an electric field, enabling the PN junction to absorb the free carriers. Therefore, the service life of free carriers inside the microring filter can be reduced, thereby lowering the heat generated by the free carrier absorption effect.

In some embodiments, the first microring filter 909 further includes a buried layer 9102 that is provided above the silicon substrate 9101, and the cladding layer 9103 is provided above the buried layer 9102. In other words, along the epitaxial growth direction, the silicon substrate 9101, the buried layer 9102, and the cladding layer 9103 are sequentially provided. The thickness of the silicon substrate 9101 may be greater than that of the buried layer 9102, and the thickness of the cladding layer 9103 may be greater than that of the silicon substrate 9101.

If the silicon waveguide ridge region 9104 within the cladding layer 9103 is directly provided on the silicon substrate 9101, the optical field generated by the silicon waveguide ridge region 9104 may leak into the silicon substrate 9101, increasing substrate leakage loss. The buried layer 9102 is provided on the silicon substrate 9101 and the silicon waveguide ridge region 9104 is provided above the buried layer 9102, the buried layer 9102 can prevent the optical field from leaking into the silicon substrate 9101, thereby reducing substrate leakage loss and ensuring the output optical power of the first microring filter 909.

In some embodiments, although the microring filter generates heat due to the two-photon absorption effect and changes the refractive index of the microring filter, the two-photon absorption effect only occurs at relatively high optical power. Due to the two-photon absorption effect, the optical power of the microring filter decreases, which reduces the number of electron hole pairs. The heat generated by the movement of electron hole pairs disappears. Therefore, the heat generated by the two-photon absorption effect in the microring filter is unstable and cannot stably change the cavity length of the resonant cavity, resulting in unstable oscillation phenomena in the output wavelength of the microring filter. To eliminate the wavelength oscillation phenomenon that occurs at the microring filter due to the two-photon absorption effect, electron hole pairs need to be absorbed via the PN junction.

In some embodiments, in order to stably change the cavity length of the resonant cavity, the first microring filter 909 further includes a heater 920. Along the epitaxial growth direction, the heater 920 is provided above the cladding layer 9103. The heater 920 may be electrically connected to the power supply chip on the circuit board 300 via wire bonding to supply power and generate heat, thereby heating the cladding layer 9103 and changing the refractive index of the first microring filter 909.

In some embodiments, the wavelength tuning chip 9031 further includes a plurality of absorbers, where the absorbers are configured to absorb the optical power of unwanted beams to avoid the generation of reflection and stray light.

The wavelength tuning chip 9031 includes a first absorber 911, a second absorber 912, a third absorber 913, and a fourth absorber 914, where the power splitter 908 is connected to the input end of the first straight optical waveguide, the first absorber 911 is connected to the output end of the first straight optical waveguide, the second absorber 912 is connected to the first output end of the second straight optical waveguide, the third absorber 913 is connected to the second output end of the second straight optical waveguide, the power splitter 908 is connected to the input end of the third straight optical waveguide, and the fourth absorber 914 is connected to the output end of the third straight optical waveguide.

The first absorber 911 is configured to absorb other beams in the first straight optical waveguide except those passing through the first microring filter 909 and the second microring filter 910, the second absorber 912 and the third absorber 913 are configured to absorb other beams in the second straight optical waveguide except those passing through the first microring filter 909 and the second microring filter 910, and the fourth absorber 914 is configured to absorb other beams in the third straight optical waveguide except those passing through the first microring filter 909 and the second microring filter 910.

Referring to FIG. 9, in some embodiments, the wavelength tuning chip 9031 further includes the phase shifter 907, where the phase shifter 907 is located between the input coupler 906 and the power splitter 908, one end of the phase shifter 907 is connected to the input coupler 906, and the other end of the phase shifter 907 is connected to the input end of the power splitter 908. The phase shifter 907 is configured to adjust the wavelength of the beam supported by the resonant cavity, such that the beams with a specific wavelength filtered by the first microring filter 909 and the second microring filter 910 coincide with the beam in the resonant cavity.

The heater is provided on the phase shifter 907. By changing the heater, the cavity length of the phase shifter 907 is changed, thereby changing the cavity length of the resonant cavity. This makes the beam with a certain wavelength supported by the resonant cavity coincide with the beam with a specific wavelength filtered by two microring filters.

In some embodiments, the first microring filter 909, the second microring filter 910, and the phase shifter 907 form a wavelength-tunable assembly, where the first microring filter 909 and the second microring filter 910 can filter out the beam with a specific wavelength from the beam in a wavelength range emitted by the semiconductor gain chip 9032, and the wavelength value is determined by the characteristics of the first microring filter 909 and the second microring filter 910 themselves. However, the resonant cavity formed by the semiconductor gain chip 9032 and the silicon photonic chip will select and support multiple beams with different wavelengths according to its own cavity structure, and the beams with multiple wavelengths supported by the resonant cavity do not necessarily coincide with the beams filtered by the two microring filters.

If the beams with multiple wavelengths supported by the resonant cavity do not coincide with the beams with specific wavelengths filtered by the two microring filters, the refractive index of the phase shifter 907 can be changed to adjust the cavity length of the phase shifter 907, thereby changing the cavity length of the resonant cavity. This makes the beam with a certain wavelength supported by the resonant cavity coincide with the beam with a specific wavelength, enabling the resonant cavity to emit the beam with a specific wavelength.

FIG. 13 is an optical path diagram of a light source assembly in an optical module according to some embodiments of the present disclosure. As shown in FIG. 9 and FIG. 13, when the laser assembly 901 serves as a light source, the semiconductor gain chip 9032 emits light within a wavelength range, and the light enters the wavelength tuning chip 9031 through the input coupler 906. After split by the power splitter 908, the input light enters the first microring filter 909 and the second microring filter 910. After one path of the split light passes through the first microring filter 909, the light with a wavelength satisfying FSR1 can pass through the first microring filter 909, and a wavelength period thereof satisfies FSR1. Then, the filtered light passes through the second microring filter 910, the light with a wavelength satisfying FSR2 can pass through the second microring filter 910, and a wavelength period thereof satisfies FSR2. Only the light with wavelengths satisfying both FSR1 and FSR2 will be output by the second microring filter 910. The beam output by the second microring filter 910 is transmitted to the semiconductor gain chip 9032 via the power splitter 908 and the input coupler 906, and the beam is reflected back and forth between the semiconductor gain chip 9032 and the wavelength tuning chip 9031, thereby enabling the semiconductor gain chip 9032 to stably output the beam with a specific wavelength.

The beam with a specific wavelength output by the semiconductor gain chip 9032 is converted into the collimated light by the first lens 9033, and the collimated light directly passes through the isolator 9034 and enters the second lens 9035. The second lens 9035 focuses the collimated light passing through the isolator 9034 onto the semiconductor amplifier chip 9036. The semiconductor amplifier chip 9036 amplifies the power of the beam with a specific wavelength, and the amplified light is converted into the collimated light by the third lens 9037. The collimated light is split into two beams by the beam splitter 9038, one beam is coupled into the internal optical fiber adapter 902 and transmitted to the coherent optical chip 1100 via the internal optical fiber adapter 902, while the other beam enters the power monitor 9039, which monitors the optical power of the beam with a specific wavelength in real time to ensure that the optical power of the beam with a specific wavelength is within a preset optical power range.

For the optical module provided by the present disclosure, a silicon filter and a silicon photonic tunable wavelength tuning chip, the silicon filter is of a microring resonant cavity structure, and PN junctions are formed on both sides of the microring waveguide by ion implantation. Compared with microring resonant cavities without integrated PN junctions, applying the reverse bias to the PN junction can rapidly absorb electron hole pairs generated by the nonlinear effect of silicon under high power, thereby eliminating wavelength oscillation caused by the nonlinear effect, and implementing a high-power, narrow-linewidth, and wide-tunable silicon photonic integrated laser. The silicon photonic integrated laser is conveniently applicable to fields such as coherent optical communication, laser radar and sensing.

An embodiment of the present disclosure further provides an optical module with another structure, the optical module not only includes a circuit board, a light source, an optical chip, a fiber adapter, and an optical fiber connecting the optical chip and the optical fiber adapter, all which are provided within the housing, but also includes a coupler assembly. The coupler assembly in this embodiment may be provided between the optical chip and the optical fiber (receiving optical fiber and transmitting optical fiber) to enable transmitting of modulated light and reception of light. Of course, the above-mentioned coupler assembly may also be provided on other components, for example, it may be provided on the optical chip, and specific understanding can be made with reference to the following examples.

FIG. 14 is a partial structural diagram of an optical module provided according to some embodiments of the present disclosure. As shown in FIG. 14, the optical chip 400 is provided on the circuit board 300, and the optical chip 400 is electrically connected to the circuit board 300. For example, the optical chip 400 is electrically connected to the circuit board 300 via wire bonding, and the periphery of the optical chip 400 is connected to the circuit board 300 by multiple conductive wires. Therefore, the optical chip 400 is generally provided on the surface of the circuit board 300.

An optical connection between the optical chip 400 and the light source 500 may be implemented via a first optical fiber ribbon, the optical chip 400 receives light from the light source 500 via the optical fiber ribbon, and the optical chip 400 modulates the light. Edge coupling between the optical chip 400 and the light source 500 may also be directly implemented, and the optical chip 400 directly receives light from the light source 500 and modulates the light.

An optical connection between the optical chip 400 and the optical fiber adapter 700 may be implemented via the transmitting optical fiber and the receiving optical fiber, and the optical fiber adapter 700 enables optical connection with an external optical fiber of the optical module. The light modulated by the optical chip 400 is transmitted to the optical fiber adapter 700 via the transmitting optical fiber, and is transmitted to the external optical fiber via the optical fiber adapter 700 to implement light transmission. The light transmitted by the external optical fiber is transmitted to the receiving optical fiber via the optical fiber adapter 700, and the light is transmitted to the optical chip 400 via the receiving optical fiber, where the optical chip 400 converts the received optical signal into an electrical signal to implement light reception.

In some embodiments, the optical chip 400 is a silicon photonic chip on which an input optical port, an output optical port, a monitoring optical port, a high-speed electrical signal interface, a DC bias signal interface, and the like are provided. The optical input port includes a first optical input port and a second input optical port, where the first optical input port (for example, local oscillator optical interface) is configured to couple the light output from the light source 500 into the silicon photonic chip, the second optical input port (for example, optical receiving interface) is configured to couple the signal light transmitted by the external optical fiber of the optical module into the silicon photonic chip, and the optical output port (for example, optical transmitting interface) is configured to couple the signal light modulated by the silicon photonic chip out of the optical chip 400.

When the optical chip 400 is coupled to the transmitting optical fiber and the receiving optical fiber, common coupling methods include edge coupling and grating coupling. The grating coupling method features easy fabrication and a large light spot, but has limitations such as high insertion loss and wavelength sensitivity. In contrast, in the edge coupling method, due to the large refractive index difference between silicon and silicon dioxide or air, the silicon waveguide has a strong ability to confine the optical field, and the size of the silicon waveguide can be made very small, the cross-sectional size thereof is typically less than 0.5 micrometers, and the core diameter of a conventional single-mode optical fiber is about 8-10 micrometers. The significant size difference between the two results in severe mode field mismatch, thereby causing substantial coupling loss.

The conventional edge coupler (Spot Size Converter, SSC) needs to prevent light from leaking into a silicon wafer substrate, and usually requires a substrate etching process to form a suspended waveguide structure, which often presents higher reliability risks compared to a solid waveguide structure. A common solid SSC design approach is to slightly reduce a mode spot size to approximately 6 μm, which can effectively decrease substrate leakage loss. However, compared to a standard single-mode optical fiber mode spot size (9 μm to 10 μm), a significant mode mismatch loss of about 1 dB is still present.

To address the above problems, the present disclosure provides an optical module for which a low-loss solid large-mode-spot SSC design is adopted. This design can avoid the use of the substrate etching process, enhance the mounting reliability of the waveguide, and further reduce the substrate leakage loss of the solid waveguide through a multilayer cladding oxide structure with different refractive indices, thereby implementing ultra-low coupling insertion loss with standard single-mode optical fibers.

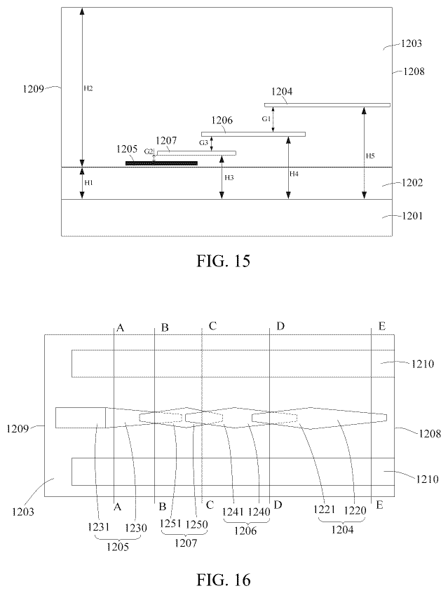

FIG. 15 is a first lateral cross-sectional view of an edge coupler in an optical module according to some embodiments of the present disclosure. As shown in FIG. 14 and FIG. 15, the optical module provided in the embodiment of the present disclosure further includes a coupler assembly, the coupler assembly may be a waveguide coupler 1200. The waveguide coupler 1200 is an edge coupler, and is located between the optical chip 400 and the transmitting optical fiber, as well as between the optical chip 400 and the receiving optical fiber. The waveguide coupler 1200 enables the coupling connection between the optical chip 400 and the transmitting optical fiber, so as to couple the signal light modulated by the optical chip 400 to the transmitting optical fiber via the waveguide coupler 1200, thereby implementing the transmission of modulated light; and couples the signal light transmitted by the receiving optical fiber to the optical chip 400 via the waveguide coupler 1200, thereby implementing the reception of light.

The waveguide coupler 1200 includes a substrate 1201, a first cladding layer 1202, and a second cladding layer 1203. Along the epitaxial growth direction, the first cladding layer 1202 is provided on the substrate 1201, and the second cladding layer 1203 is provided on the first cladding layer 1202, such that the substrate 1201, first cladding layer 1202, and the second cladding layer 1203 are sequentially arranged along the epitaxial growth direction.

In some embodiments, the substrate 1201 is a silicon-on-insulator (SOI) substrate that is commonly used for silicon-based devices. The SOI substrate typically includes a silicon substrate and a buried oxide layer provided on the silicon substrate, with the thickness of the buried oxide layer usually being 3 μm. It should be noted that a complete SOI substrate typically further includes a top silicon layer provided on the buried oxide layer, with the thickness of the top silicon layer usually being 220 nm. However, during the fabrication of the edge coupler, in order to prevent light from being drawn into the top silicon layer, the top silicon layer is removed to expose the buried oxide layer, and subsequent processing is performed on the buried oxide layer.

The first cladding layer 1202 is provided on one side of the buried oxide layer opposite to the silicon substrate, and may be a silicon dioxide cladding layer. The refractive index of the first cladding layer 1202 is lower than that of the substrate 1201.

The second cladding layer 1203 is provided on one side of the first cladding layer 1202 opposite to the substrate 1201, such that the second cladding layer 1203 is supported by the first cladding layer 1202. The second cladding layer 1203 may be a silicon nitride cladding layer, and the refractive index of the second cladding layer 1203 is higher than that of the first cladding layer 1202. Thus, along the epitaxial growth direction, the refractive index of the waveguide coupler 1200 decreases and then increases, which can provide better confinement of the optical field in the longitudinal direction and prevent light within the second cladding layer 1203 from leaking into the substrate 1201.

In some embodiments, the thickness of the first cladding layer 1202 is a first thickness H1, and the thickness of the second cladding layer 1203 is a second thickness H2, where the second thickness H2 is greater than the first thickness H1 to facilitate the provision of the coupling waveguide within the second cladding layer 1203.

In some embodiments, the first thickness H1 ranges from 2 μm to 3 μm, and the second thickness H2 ranges from 6 μm to 10 μm.

The second cladding layer 1203 has a first end face 1208 for optical coupling with the optical fiber and a second end face 1209 for optical coupling with the optical chip 400. The coupling waveguide may be provided within the second cladding layer 1203, one end of the coupling waveguide is adjacent to the first end face 1208 and the other end thereof is adjacent to the second end face 1209, such that one end of the coupling waveguide is coupled to the optical fiber to receive optical signals, and the coupling waveguide can directionally guide the optical signal along its own extension direction, coupling the transmitted optical signal to the optical chip 400, thereby implementing coupling connection between the optical chip 400 and the optical fiber via the coupling waveguide.

The coupling waveguide may be a tapered waveguide, where one end of the coupling waveguide configured to couple with the optical fiber is referred to as a tip, and one end of the coupling waveguide configured to connect to the optical chip 400 is referred to as a base. The tip has a small size to match the mode field of the optical fiber, while the base has a large size to match the optical chip 400. In actual design, the widths of the tip and the base and the overall thickness of the coupling waveguide can be designed according to actual requirements.

The coupling waveguide within the second cladding layer 1203 includes a first coupling waveguide 1204 and a second coupling waveguide 1205. One end of the first coupling waveguide 1204 is close to a first end face 1208, such that the first coupling waveguide 1204 is coupled to the optical fiber; the first coupling waveguide 1204 is used to confine the light transmitted by the optical fiber within a predetermined mode field size. One end of the second coupling waveguide 1205 is close to a second end face 1209, such that the second coupling waveguide 1205 is optically coupled to the optical chip 400; and the second coupling waveguide 1205 is used to couple the light confined within the predetermined mode field by the first coupling waveguide 1204 into the optical chip 400. The first coupling waveguide 1204 and the second coupling waveguide 1205 are coupled, thereby enabling optical coupling between the optical fiber and the optical chip 400 via the first coupling waveguide 1204 and the second coupling waveguide 1205.

In some embodiments, when the waveguide coupler 1200 implements coupling connection between the optical fiber and the optical chip 400 via the first coupling waveguide 1204 and the second coupling waveguide 1205, the position of the first coupling waveguide 1204 within the second cladding layer 1203 needs to correspond to the optical fiber. When a gap between the first coupling waveguide 1204 and the second coupling waveguide 1205 exceeds a preset range, that is, when the position of the optical fiber is relatively high, the first coupling waveguide 1204 is far away from the substrate 1201, which affects the coupling efficiency between the first coupling waveguide 1204 and the second coupling waveguide 1205. To improve the coupling efficiency between the first coupling waveguide 1204 and the second coupling waveguide 1205, a transition waveguide may be provided between the first coupling waveguide 1204 and the second coupling waveguide 1205, such that the higher optical field at the end face of the waveguide coupler 1200 is gradually transitioned layer by layer to the lower waveguide via the transition waveguide, and finally reaches the coupling waveguide closer to the substrate 1201.

The waveguide coupler 1200 includes at least one transition waveguide that is located between the first coupling waveguide 1204 and the second coupling waveguide 1205. There is a first gap between the first coupling waveguide 1204 and the at least one transition waveguide, and a second gap between the second coupling waveguide 1205 and the at least one transition waveguide.

A large gap between waveguides leads to great coupling difficulty. In order to reduce the coupling difficulty among the first coupling waveguide 1204, the at least one transition waveguide, and the second coupling waveguide 1205, a second gap G2 is less than a first gap G1, such that the high optical field at the first end face 1208 is gradually transitioned from the first coupling waveguide 1204 to the at least one transition waveguide, and finally reaches the second coupling waveguide 1205. During the transition of the optical field, leakage of the optical field within the second cladding layer 1203 into the substrate 1201 is avoided.

To enable the optical signal transmitted by the first coupling waveguide 1204 to be coupled into the at least one transition waveguide, and the optical signal transmitted by the at least one transition waveguide to be coupled into the second coupling waveguide 1205, there is a first overlapping portion between the first coupling waveguide 1204 and the at least one transition waveguide, and a second overlapping portion between the second coupling waveguide 1205 and the at least one transition waveguide. The length of the second overlapping portion is less than that of the first overlapping portion, so as to ensure the coupling efficiency among the first coupling waveguide 1204, the at least one transition waveguide, and the second coupling waveguide 1205, and reduce leakage of the optical field within the second cladding layer 1203 into the substrate 1201.

Referring to FIG. 15, in some embodiments, the waveguide coupler 1200 may include a first transition waveguide 1206 and a second transition waveguide 1207 that are both located within the second cladding layer 1203. Along the epitaxial growth direction, the first transition waveguide 1206 is located between the first coupling waveguide 1204 and the second coupling waveguide 1205, and the second transition waveguide 1207 is located between the first transition waveguide 1206 and the second coupling waveguide 1205. One end of the first coupling waveguide 1204 is coupled to the optical fiber, and the other end thereof is coupled to one end of the first transition waveguide 1206. The other end of the first transition waveguide 1206 is coupled to one end of the second transition waveguide 1207. The other end of the second transition waveguide 1207 is coupled to one end of the second coupling waveguide 1205, and the other end of the second coupling waveguide 1205 is optically coupled to the optical chip 400. Thus, the coupling connection between the optical fiber and the optical chip 400 is implemented via the first coupling waveguide 1204, the first transition waveguide 1206, the second transition waveguide 1207, and the second coupling waveguide 1205.

In some embodiments, there is a third height H3 between the second transition waveguide 1207 and an upper surface of the substrate 1201, a fourth height H4 between the first transition waveguide 1206 and the upper surface of the substrate 1201, and a fifth height H5 between the first coupling waveguide 1204 and the upper surface of the substrate 1201. The second coupling waveguide 1205 is adjacent to the first cladding layer 1202. The fifth height H5 is greater than the fourth height H4, and the fourth height H4 is greater than the third height H3.

There is the first gap G1 between the first coupling waveguide 1204 and the first transition waveguide 1206, the second gap G2 between the second coupling waveguide 1205 and the second transition waveguide 1207, and a third gap G3 between the first transition waveguide 1206 and the second transition waveguide 1207. The large gap between waveguides leads to the great coupling difficulty. In order to reduce the coupling difficulty among the first coupling waveguide 1204 and the first transition waveguide 1206, the first transition waveguide 1206 and the second transition waveguide 1207, and the second transition waveguide 1207 and the second coupling waveguide 1205, the first gap G1 is greater than the second gap G2, and the third gap G3 is greater than the second gap G2, such that the high optical field at the first end face 1208 is gradually transitioned from the first transition waveguide 1206 to the second transition waveguide 1207, and finally reaches the second coupling waveguide 1205. During the transition of the optical field, leakage of the optical field within the second cladding layer 1203 into the substrate 1201 is avoided.

In some embodiments, the third height H3 ranges from 2 μm to 4 μm, the fourth height H4 ranges from 3 μm to 6 μm, the fifth height H5 ranges from 3 μm to 6 μm, the first gap G1 ranges from 0.5 μm to 2 μm, the second gap G2 ranges from 0.1 μm to 0.8 μm, and the third gap G3 ranges from 0.5 μm to 2 μm.

In some embodiments, the first gap G1 may be greater than the third gap G3, such that the first gap G1, the third gap G3, and the second gap G2 gradually decrease, that is, along a light receiving direction, the gap between waveguides within the waveguide coupler 1200 gradually decreases.

In some embodiments, the first gap G1 may also be less than the third gap G3, and the first gap G1 is greater than the second gap G2, such that there is no regularity among the first gap G1, the third gap G3, and the second gap G2.

In some embodiments, to improve the coupling efficiency between waveguides, the large gap between waveguides leads to the long overlap length between waveguides. For example, the first gap G1 is 1.3 μm, and the length of the first overlapping portion between the first coupling waveguide 1204 and the first transition waveguide 1206 is 400 μm; the second gap G2 is 0.43 μm, and the length of the second overlapping portion between the second coupling waveguide 1205 and the second transition waveguide 1207 is 100 μm; and the third gap is 0.85 μm, and the length of the third overlapping portion between the first transition waveguide 1206 and the second transition waveguide 1207 is 200 μm.

In some embodiments, the first coupling waveguide 1204, the first transition waveguide 1206, the second transition waveguide 1207, and the second coupling waveguide 1205 are supported on the second cladding layer 1203 by the first cladding layer 1202 located beneath them, and are further supported on the substrate 1201 via the second cladding layer 1203. That is, the second cladding layer 1203 that covers the first coupling waveguide 1204, the first transition waveguide 1206, the second transition waveguide 1207, and the second coupling waveguide 1205 is supported on the substrate 1201 through the first cladding layer 1202, enabling the first coupling waveguide 1204, the first transition waveguide 1206, the second transition waveguide 1207, and the second coupling waveguide 1205 to be effectively supported by the substrate 1201, thereby avoiding the use of substrate etching processes and enhancing the mounting reliability of the first coupling waveguide 1204, the first transition waveguide 1206, the second transition waveguide 1207, and the second coupling waveguide 1205.

Since the refractive index of the first coupling waveguide 1204, the first transition waveguide 1206, the second transition waveguide 1207, and the second coupling waveguide 1205 is greater than that of a second cladding layer 1203, and the refractive index of the second cladding layer 1203 is higher than that of the first cladding layer 1202, light transmitted through the first coupling waveguide 1204, the first transition waveguide 1206, the second transition waveguide 1207, and the second coupling waveguide 1205 is difficult to leak from the second cladding layer 1203 into the first cladding layer 1202, thereby reducing the leakage of optical signals into the substrate 1201. As a result, the substrate leakage loss of the coupling waveguide can be reduced, which is beneficial for improving the optical signal coupling efficiency from the optical fiber to the optical chip 400.

FIG. 16 is a top view of an edge coupler in an optical module according to some embodiments of the present disclosure. As shown in FIG. 16, to facilitate mode field matching between the first coupling waveguide 1204 and the optical fiber, and mode matching among the first coupling waveguide 1204, the first transition waveguide 1206, the second transition waveguide 1207, and the second coupling waveguide 1205, a tapered structure is adopted for the first coupling waveguide 1204, the first transition waveguide 1206, the second transition waveguide 1207, and the second coupling waveguide 1205.

The first coupling waveguide 1204 includes a first tapered waveguide 1220 and a second tapered waveguide 1221, where the tip of the first tapered waveguide 1220 is adjacent to the first end face 1208, and the tip of the second tapered waveguide 1221 faces in an opposite direction to the tip of the first tapered waveguide 1220, that is, the tip of the first tapered waveguide 1220 is adjacent to the first end face 1208, while the tip of the second tapered waveguide 1221 is away from the first end face 1208.

In some embodiments, the tip of the first tapered waveguide 1220 is coupled to the transmitting optical fiber or the receiving optical fiber, and the tip has a relatively small width, such that the optical mode at the tip is distributed within the second cladding layer 1203, better matching the optical mode transmitted by the externally coupled optical fiber. In other words, the distribution of the optical field at the tip overlaps more closely with the distribution of the optical field in the optical fiber, resulting in higher coupling efficiency.

In some embodiments, the base of the first tapered waveguide 1220 may be directly connected to the base of the second tapered waveguide 1221, and the width of the base is greater than the width of the tip, such that the refractive index of the base is higher than that of the tip, facilitating the coupling of light from the tip to the base.

In some embodiments, the first coupling waveguide 1204 may further include a straight optical waveguide that is connected to the first tapered waveguide 1220 and the second tapered waveguide 1221. The width of the straight optical waveguide is the same as the widths of the bases of the first tapered waveguide 1220 and the second tapered waveguide 1221, that is, the base of the first tapered waveguide 1220 is connected to one end of the straight optical waveguide, and the base of the second tapered waveguide 1221 is connected to the other end of the straight optical waveguide, such that the first tapered waveguide 1220 and the second tapered waveguide 1221 are connected via the intermediate straight optical waveguide.

The first transition waveguide 1206 includes a third tapered waveguide 1240 and a fourth tapered waveguide 1241 that are connected, where the tip of the third tapered waveguide 1240 faces the second tapered waveguide 1221, and the third tapered waveguide 1240 and the second tapered waveguide 1221 have an overlapping portion. The first transition waveguide 1206 is used to receive optical signals transmitted by the first coupling waveguide 1204.

The second transition waveguide 1207 includes a fifth tapered waveguide 1250 and a sixth tapered waveguide 1251 that are connected, where the tip of the fifth tapered waveguide 1250 faces the fourth tapered waveguide 1241, and the fifth tapered waveguide 1250 and the fourth tapered waveguide 1241 have an overlapping portion. The second transition waveguide 1207 is used to receive optical signals transmitted by the first transition waveguide 1206.

The second coupling waveguide 1205 includes a seventh tapered waveguide 1230 and a straight optical waveguide 1231, where the tip of the seventh tapered waveguide 1230 faces the sixth tapered waveguide 1251, and the seventh tapered waveguide 1230 and the sixth tapered waveguide 1251 have an overlapping portion. The second coupling waveguide 1205 is used to receive optical signals transmitted by the second transition waveguide 1207 and to couple the optical signals to the optical chip 400.

The base of the seventh tapered waveguide 1230 is connected to the straight optical waveguide 1231, and the straight optical waveguide 1231 is adjacent to the second end face 1209. The optical field within the seventh tapered waveguide 1230 is coupled to the straight optical waveguide 1231, and the straight optical waveguide 1231 is used to couple the optical signal to the optical chip 400 to implement optical reception.

In some embodiments, the first coupling waveguide 1204 may be a silicon nitride waveguide, and the second coupling waveguide 1205 may be a silicon waveguide. The refractive index of silicon nitride is about 2.0 and is lower than that of silicon, so a silicon nitride waveguide with a larger dimension can be fabricated. This reduces the coupling loss between the first coupling waveguide 1204 and the single-mode optical fiber. In addition, silicon nitride has lower propagation loss, and fabricating the silicon nitride waveguide with silicon nitride can reduce the transmission loss between the first coupling waveguide 1204 and the single-mode optical fiber.

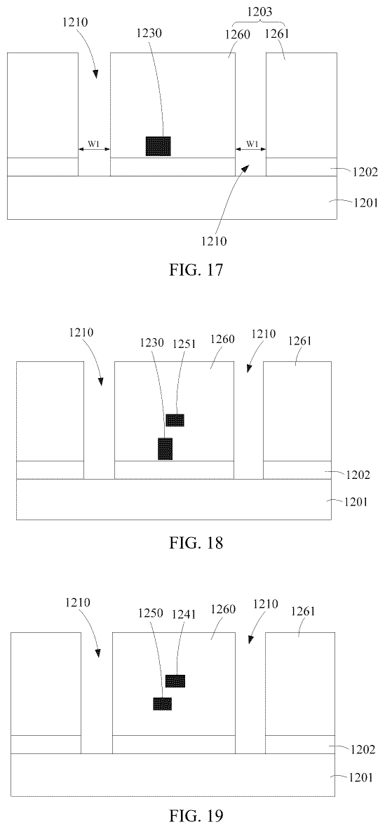

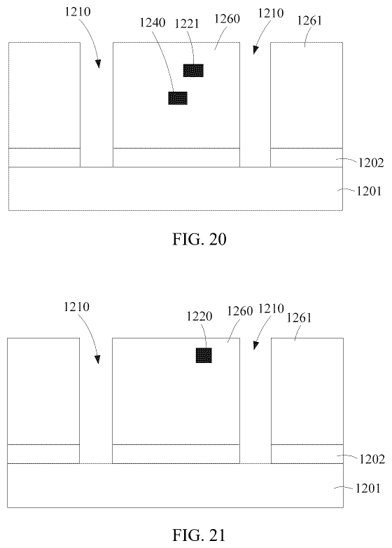

FIG. 17 is an A-A cross-sectional view in FIG. 16; FIG. 18 is a B-B cross-sectional view in FIG. 16; FIG. 19 is a C-C cross-sectional view in FIG. 16; FIG. 20 is a D-D cross-sectional view in FIG. 16; and FIG. 21 is an E-E cross-sectional view in FIG. 16. As shown in FIG. 17 to FIG. 21, the thickness of the first coupling waveguide 1204 is less than that of the second coupling waveguide 1205, and the cross-sectional dimensions of the first coupling waveguide 1204 and the second coupling waveguide 1205 may differ. When light is coupled among the first coupling waveguide 1204, the first transition waveguide 1206, the second transition waveguide 1207, and the second coupling waveguide 1205, the transmission mode of light has a discontinuity due to the different cross-sections of the optical waveguides, which causes loss and polarization dependent loss. Therefore, a special structure is designed at the coupling regions among the first coupling waveguide 1204, the first transition waveguide 1206, the second transition waveguide 1207, and the second coupling waveguide 1205 to reduce loss and polarization dependent loss.

The width of the second tapered waveguide 1221 of the first coupling waveguide 1204 and the width of the third tapered waveguide 1240 of the first transition waveguide 1206 are designed, such that in the overlapping portion between the first coupling waveguide 1204 and the first transition waveguide 1206, the lateral width of the second tapered waveguide 1221 gradually narrows, while the lateral width of the third tapered waveguide 1240 gradually widens, slowly releasing the optical field transmitted in the first coupling waveguide 1204 into the first transition waveguide 1206. This ensures that there is no mode discontinuity during coupling of light between the first coupling waveguide 1204 and the first transition waveguide 1206, and the mode conversion approximately satisfies the adiabatic condition, that is, both TE-polarized light and TM-polarized light can be efficiently coupled into the first coupling waveguide 1204 or the first transition waveguide 1206, reducing polarization dependent loss and improving coupling efficiency.

The width of the fourth tapered waveguide 1241 of the first transition waveguide 1206 and the width of the fifth tapered waveguide 1250 of the second transition waveguide 1207 are designed, such that in the overlapping portion between the first transition waveguide 1206 and the second transition waveguide 1207, the lateral width of the fourth tapered waveguide 1241 gradually narrows, while the lateral width of the fifth tapered waveguide 1250 gradually widens, slowly releasing the optical field transmitted in the first transition waveguide 1206 into the second transition waveguide 1207. This ensures that there is no mode discontinuity during coupling of light between the first transition waveguide 1206 and the second transition waveguide 1207, and the mode conversion approximately satisfies the adiabatic condition, that is, both TE-polarized light and TM-polarized light can be efficiently coupled into the first transition waveguide 1206 or the second transition waveguide 1207, reducing polarization dependent loss and improving coupling efficiency.

The width of the sixth tapered waveguide 1251 of the second transition waveguide 1207 and the width of the seventh tapered waveguide 1230 of the second coupling waveguide 1205 are designed, such that in the overlapping portion between the second transition waveguide 1207 and the second coupling waveguide 1205, the lateral width of the sixth tapered waveguide 1251 gradually narrows, while the lateral width of the seventh tapered waveguide 1230 gradually widens, slowly releasing the optical field transmitted in the second transition waveguide 1207 into the second coupling waveguide 1205. This ensures that there is no mode discontinuity during coupling of light between the second transition waveguide 1207 and the second coupling waveguide 1205, and the mode conversion approximately satisfies the adiabatic condition, that is, both TE-polarized light and TM-polarized light can be efficiently coupled into the second transition waveguide 1207 or the second coupling waveguide 1205, reducing polarization dependent loss and improving coupling efficiency.

Since the refractive index of the first coupling waveguide 1204, the first transition waveguide 1206, the second transition waveguide 1207, and the second coupling waveguide 1205 is greater than that of a second cladding layer 1203, and the refractive index of the second cladding layer 1203 is higher than that of the first cladding layer 1202, light transmitted through the first coupling waveguide 1204, the first transition waveguide 1206, the second transition waveguide 1207, and the second coupling waveguide 1205 is difficult to leak from the second cladding layer 1203 into the first cladding layer 1202, thereby reducing the leakage of optical signals into the substrate 1201. As a result, the substrate leakage loss of the coupling waveguide can be reduced, which is beneficial for improving the optical signal coupling efficiency from the optical fiber to the optical chip 400.

In some embodiments, a first cladding layer 1202 with a lower refractive index is additionally provided between the second cladding layer 1203 and the substrate 1201, which can implement better vertical confinement of the optical field within the second cladding layer 1203. To enhance the horizontal confinement of the optical field within the second cladding layer 1203, side grooves 1210 are provided in the first cladding layer 1202 and the second cladding layer 1203, and located on both sides of the first coupling waveguide 1204, the first transition waveguide 1206, the second transition waveguide 1207, and the second coupling waveguide 1205.

Referring to FIG. 16 and FIG. 17, side grooves 1210 are provided on both sides of the first coupling waveguide 1204, the first transition waveguide 1206, the second transition waveguide 1207, and the second coupling waveguide 1205. The side grooves 1210 may be located within the first cladding layer 1202 and the second cladding layer 1203, and an opening is formed on one side, away from the substrate 1201, of the side groove 1210, thereby forming U-shaped side grooves 1210 on the first cladding layer 1202 and the second cladding layer 1203.

In some embodiments, air grooves are etched on both sides of the first coupling waveguide 1204 and the second coupling waveguide 1205 within the second cladding layer 1203, and an adhesive is filled in the air grooves during coupling packaging. The refractive index of the adhesive is lower than that of the second cladding layer 1203, and the side grooves 1210 are bilaterally symmetric with respect to the first coupling waveguide 1204 and the second coupling waveguide 1205, which also simulates the transverse refractive index distribution of the optical fiber to enhance the horizontal confinement of the optical field.

Along the width direction of the waveguide coupler 1200, the second cladding layer 1203 is divided into two separate portions by the side grooves 1210, namely, a central portion 1260 and a peripheral portion 1261. The central portion 1260 is located on the inner side and surrounds the periphery of the first coupling waveguide 1204 and the second coupling waveguide 1205; and the peripheral portion 1261 is annularly arranged outside the central portion 1260 and also plays a role of support and protection.

The side grooves 1210 are provided on the second cladding layer 1203, such that the distribution of the mode field formed jointly by the central portion 1260 and the first coupling waveguide 1204 in a plane where the waveguide coupler 1200 is in contact with the optical fiber can be better matched with the distribution of the mode field of the optical fiber, reducing the coupling loss at the first end face 1208 where the waveguide coupler 1200 is in contact with the optical fiber.

In some embodiments, in the first end face 1208 where the waveguide coupler 1200 is in contact with the optical fiber, the central portion 1260 and the first coupling waveguide 1204 jointly form a receiving mode field, while the optical fiber has a transmitting mode field. The high degree of matching between the distribution of the receiving mode field and the distribution of the transmitting mode field indicates the low optical signal loss. Therefore, the distribution of the receiving mode field can be changed by adjusting the size of the central portion 1260, namely, adjusting the width W1 of the side groove 1210. The distribution of the receiving mode field can be changed to better match the distribution of the transmitting mode field in the optical fiber, thereby reducing optical signal loss.

In some embodiments, the width W1 of the side groove 1210 is greater than 2 μm.

The side groove 1210 may be a trench structure built on the substrate 1201, that is, the bottom surface of the side groove 1210 is exactly located on the surface of the substrate 1201, such that part of the upper surface of the substrate 1201 is exposed from the bottom surface of the side groove 1210.

The bottom surface of the side groove 1210 may also be located within the first cladding layer 1202, or within the second cladding layer 1203, that is, the bottom surface of the side groove 1210 may be separated from the surface of the substrate 1201 by a certain distance.

In some embodiments, the bottom surface of the side groove 1210 may further pass through the first cladding layer 1202 into the substrate 1201, that is, the bottom surface of the side groove 1210 is located below the surface of the substrate 1201.

In some embodiments, the side groove 1210 may be a polygonal trench, that is, the side groove 1210 may have a polygonal horizontal cross-section, such as a rectangular trench or a trapezoidal trench.

In some embodiments, the dielectric filled within the side groove 1210 may be air, or may be another dielectric material with a refractive index lower than that of the second cladding layer 1203.

In some embodiments, the side groove 1210 may be formed directly by a one-step etching process. For example, a first cladding layer 1202 made of silicon dioxide may be deposited on the substrate 1201, a second cladding layer 1203 made of silicon nitride may be deposited on the first cladding layer 1202, a first coupling waveguide 1204 and a second coupling waveguide 1205 may be formed within the second cladding layer 1203, and then the side grooves 1210 may be formed by downward etching on the surfaces of the second cladding layers 1203 on both sides of the first coupling waveguide 1204 and the second coupling waveguide 1205.

The side grooves 1210 are provided on both sides of the first coupling waveguide 1204 and the second coupling waveguide 1205, where the optical field of the second cladding layer 1203 can be confined within a range close to the mode field size of the single-mode optical fiber, thereby implementing optimal mode field matching with a standard single-mode optical fiber and effectively reducing insertion loss compared to designs without side grooves.

In some embodiments, the transition waveguide between the first coupling waveguide 1204 and the second coupling waveguide 1205 may include not only the first transition waveguide 1206 and the second transition waveguide 1207, but the number of transition waveguides may also be determined according to the position of the optical fiber.

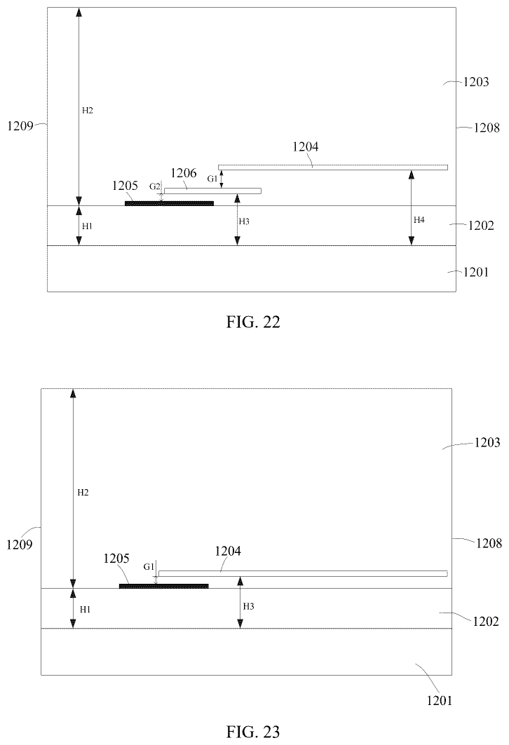

FIG. 22 is a second lateral cross-sectional view of an edge coupler in an optical module according to some embodiments of the present disclosure. As shown in FIG. 22, the waveguide coupler 1200 further includes a first transition waveguide 1206, where the first transition waveguide 1206 is located within the second cladding layer 1203. Along the epitaxial growth direction, the first transition waveguide 1206 is located above the second coupling waveguide 1205. The first coupling waveguide 1204 is located above the first transition waveguide 1206, one end of the first coupling waveguide 1204 is coupled to the optical fiber, the other end of the first coupling waveguide 1204 is coupled to one end of the first transition waveguide 1206, and the other end of the first transition waveguide 1206 is coupled to one end of the second coupling waveguide 1205. The second coupling waveguide 1205 is optically connected to the optical chip 400, such that coupling between the optical fiber and the optical chip 400 is implemented via the first coupling waveguide 1204, the first transition waveguide 1206, and the second coupling waveguide 1205.

In some embodiments, a third height H3 is provided between the first transition waveguide 1206 and the upper surface of the substrate 1201, and a fourth height H4 is provided between the first coupling waveguide 1204 and the upper surface of the substrate 1201, where the fourth height H4 is greater than the third height H3. The second coupling waveguide 1205 is adjacent to the first cladding layer 1202. A first gap G1 is provided between the first coupling waveguide 1204 and the first transition waveguide 1206, and a first overlapping portion is provided between the first coupling waveguide 1204 and the first transition waveguide 1206. A second gap G2 is provided between the first transition waveguide 1206 and the second coupling waveguide 1205, and a second overlapping portion is provided between the second coupling waveguide 1205 and the first transition waveguide 1206.

A large gap between waveguides leads to great coupling difficulty. In order to reduce the coupling difficulty between the first transition waveguide 1206 and the second coupling waveguide 1205, the second gap G2 is less than the first gap G1. The length of the second overlapping portion is less than the length of the first overlapping portion, such that the high optical field at the first end face 1208 is gradually transitioned to the first transition waveguide 1206, and finally reaches the second coupling waveguide 1205. During the transition of the optical field, leakage of the optical field within the second cladding layer 1203 into the substrate 1201 is avoided.

In some embodiments, the third height H3 ranges from 2 μm to 4 μm, the fourth height H4 ranges from 3 μm to 6 μm, the first gap G1 ranges from 0.5 μm to 2 μm, and the second gap G2 ranges from 0.1 μm to 0.8 μm.

In some embodiments, to improve the coupling efficiency between waveguides, the large gap between waveguides leads to the long overlap length between waveguides. Thus, the first gap G1 is 1.5 μm, the length of the first overlapping portion is 600 μm, the second gap G2 is 0.78 μm, and the length of the second overlapping portion is 300 μm.

In some embodiments, according to the position of the optical fiber, a transition waveguide may not be provided between the first coupling waveguide 1204 and the second coupling waveguide 1205, that is, the waveguide coupler 1200 includes only the first coupling waveguide 1204 and the second coupling waveguide 1205.

FIG. 23 is a third lateral cross-sectional view of an edge coupler in an optical module according to some embodiments of the present disclosure. As shown in FIG. 23, along the epitaxial growth direction, the first coupling waveguide 1204 is located above the second coupling waveguide 1205, and the second coupling waveguide 1205 may be adjacent to the first cladding layer 1202. The position of the first coupling waveguide 1204 within the second cladding layer 1203 corresponds to the transmitting optical fiber and the receiving optical fiber. For example, a third height H3 is provided between the first coupling waveguide 1204 and the side surface of the substrate 1201 facing the first cladding layer 1202, and a first gap G1 is provided between the first coupling waveguide 1204 and the second coupling waveguide 1205. The large first gap G1 indicates large coupling difficulty between the first coupling waveguide 1204 and the second coupling waveguide 1205. Therefore, the first gap G1 needs to be within a preset range to ensure the coupling efficiency between the first coupling waveguide 1204 and the second coupling waveguide 1205 and to reduce leakage of the optical field in the second cladding layer 1203 into the substrate 1201.

In some embodiments, the third height H3 between the first coupling waveguide 1204 and the substrate 1201 ranges from 2 μm to 4 μm, and the first gap G1 between the first coupling waveguide 1204 and the second coupling waveguide 1205 ranges from 0.1 μm to 0.8 μm.

In some embodiments, the refractive index of the first coupling waveguide 1204 is higher than that of the second cladding layer 1203, the refractive index of the second coupling waveguide 1205 is higher than that of the second cladding layer 1203, and the first gap G1 between the first coupling waveguide 1204 and the second coupling waveguide 1205 is within a preset range, such that light transmitted by the first coupling waveguide 1204 can be gradually coupled from the first coupling waveguide 1204 to the second coupling waveguide 1205, or light transmitted by the second coupling waveguide 1205 can be gradually coupled from the second coupling waveguide 1205 to the first coupling waveguide 1204.

Thus, the signal light modulated by the optical chip 400 is coupled to the second coupling waveguide 1205, the signal light is coupled to the first coupling waveguide 1204 through the second coupling waveguide 1205, the signal light is coupled to the transmitting optical fiber through the first coupling waveguide 1204, and the signal light is transmitted to the optical fiber adapter 700 and then the external optical fiber through the transmitting optical fiber, thereby implementing optical transmission.

The received light transmitted by the external optical fiber is transmitted to the receiving optical fiber via the optical fiber adapter 700, and the received light is coupled to the first coupling waveguide 1204 via the receiving optical fiber. The received light is coupled to the second coupling waveguide 1205 through the first coupling waveguide 1204, the received light is coupled to the optical chip 400 through the second coupling waveguide 1205, and the optical chip 400 converts the received optical signal into an electrical signal, thereby implementing optical reception.

In some embodiments, the refractive index of the first cladding layer 1202 may be a single refractive index, or the refractive index of the first cladding layer 1202 may be a graded refractive index, that is, along the epitaxial growth direction, the refractive index of the first cladding layer 1202 gradually decreases. The refractive index of the first cladding layer 1202 near the lower surface is lower than that of the substrate 1201, and the refractive index of the first cladding layer 1202 near the upper surface is lower than that of the second cladding layer 1203, so as to prevent leakage of the optical field in the second cladding layer 1203 into the substrate 1201.

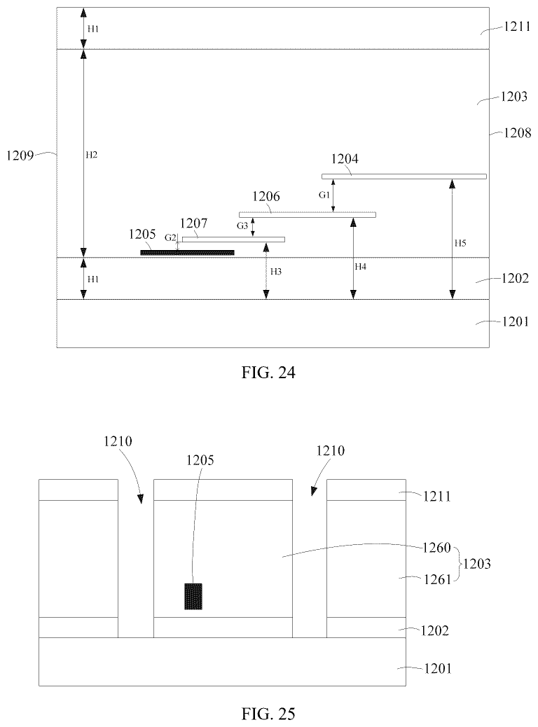

FIG. 24 is a fourth lateral cross-sectional view of an edge coupler in an optical module according to some embodiments of the present disclosure, and FIG. 25 is a longitudinal cross-sectional view of an edge coupler in an optical module according to some embodiments of the present disclosure. As shown in FIG. 24 and FIG. 25, in some embodiments, the waveguide coupler 1200 may further include a third cladding layer 1211. Along the epitaxial growth direction, the first cladding layer 1202 is located on the substrate 1201, the second cladding layer 1203 is located on the first cladding layer 1202, and the third cladding layer 1211 is located on the second cladding layer 1203. The first cladding layer 1202 and the third cladding layer 1211 are vertically symmetrical with respect to the second cladding layer 1203, and the refractive index of the third cladding layer 1211 is lower than that of the second cladding layer 1203.

In some embodiments, the refractive index of the first cladding layer 1202 is the same as that of the third cladding layer 1211, so as to simulate the refractive index distribution of an optical fiber and implement better vertical confinement of the optical field.

In some embodiments, the refractive index of the first cladding layer 1202 being the same as that of the third cladding layer 1211 refers to theoretical equality of refractive index. As long as the error between the refractive index of the first cladding layer 1202 and the refractive index of the third cladding layer 1211 falls within a preset error range, the refractive index of the first cladding layer 1202 and the refractive index of the third cladding layer 1211 can be considered the same.

The first cladding layer 1202 and the third cladding layer 1211 are configured to reflect light leaked from the second cladding layer 1203, such that the light can only be transmitted within the second cladding layer 1203. This is designed based on the same concept. If there is a deviation in the refractive index of the first cladding layer 1202 and the refractive index of the third cladding layer 1211 due to manufacturing differences or individual differences, the refractive index of the first cladding layer 1202 and the refractive index of the third cladding layer 1211 can still be considered the same.

A first coupling waveguide 1204, a first transition waveguide 1206, a second transition waveguide 1207, and a second coupling waveguide 1205 are provided inside the second cladding layer 1203. One end of the first coupling waveguide 1204 is coupled to the optical fiber, the other end of the first coupling waveguide 1204 is coupled to one end of the first transition waveguide 1206, the other end of the first transition waveguide 1206 is coupled to one end of the second transition waveguide 1207, the other end of the second transition waveguide 1207 is coupled to one end of the second coupling waveguide 1205, and the other end of the second coupling waveguide 1205 is optically connected to the optical chip 400, so as to implement optical coupling between the optical fiber and the optical chip 400 through the waveguide coupler 1200.

Side grooves 1210 are etched on both sides of the waveguide inside the second cladding layer 1203. The refractive index of the dielectric filled in the side grooves 1210 is lower than that of the second cladding layer 1203, so as to simulate the transverse refractive index distribution of the optical fiber, thereby enhancing the horizontal confinement of the optical field within the second cladding layer 1203 through the side grooves.

When light is transmitted in the first coupling waveguide 1204, the second transition waveguide 1207, the first transition waveguide 1206, and the second coupling waveguide 1205, since the refractive indices of the second cladding layer 1203 are higher than the refractive index of the first cladding layer 1202 and the refractive index of the third cladding layer 1211, the light leaked into the second cladding layer 1203 will be reflected at the first cladding layer 1202 and the third cladding layer 1211. The reflected light can be coupled into the coupling waveguide or transition waveguide and is difficult to leak to the substrate 1201, thereby reducing substrate leakage loss and implementing ultra-low coupling insertion loss for standard single-mode optical fibers.

Certainly, in addition to the above method of providing the coupler assembly between the optical chip and the optical fiber to improve the optical coupling efficiency thereof, the coupler assembly may also be provided at the optical port of the optical chip, which can be understood with reference to the following examples. In addition, the coupler assembly may be provided both between the optical chip and the optical fiber, and at the optical port of the optical chip, so as to improve the optical coupling efficiency between the optical chip and the optical fiber.

In some embodiments, the coupler assembly is an optical coupler.

Referring to FIG. 14, the optical chip 400 is configured to modulate and demodulate optical signals: the optical chip 400 modulates received electrical signals into optical signals, and demodulates received optical signals into electrical signals.

In some embodiments, the optical chip 400 may be a monolithically integrated optical chip. Monolithic integration refers to the direct epitaxial growth of optical device materials on a single substrate to fabricate optical devices with desired functions.

For example, the optical chip 400 may be a monolithically integrated silicon photonic chip. Silicon materials are easy to etch, so functional devices can be integrated inside the silicon photonic chip. The silicon materials have good integrability. For example, beam splitters, beam combiners, frequency mixers, photodetectors and the like can be integrated inside the silicon photonic chip. As an indirect band gap semiconductor material, silicon has no linear electro-optic effect but only has a weak second-order electro-optic effect, resulting in a relatively low modulation rate of the silicon photonic chip.

For example, the optical chip 400 may be a monolithically integrated thin-film lithium niobate chip. Thin-film lithium niobate exhibits the linear electro-optic effect, and an applied electric field causes a linear change in the refractive index in the corresponding direction, such that the light wave transmitted in the dielectric has controllable intensity, phase, and other information. Therefore, thin-film lithium niobate may be selected as the material for the optical modulator, thereby implementing a high modulation rate and other performance advantages. Thin-film lithium niobate material is relatively hard and difficult to etch, making it difficult to integrate multiple functional devices on its surface. Meanwhile, thin-film lithium niobate chips have relatively low optical loss.

In some embodiments, the optical chip 400 may be a hybrid integrated optical chip. Hybrid integration refers to fabricating optical devices on different substrates according to the advantages of their respective material systems and the characteristics of their fabrication processes, and then integrating them together. The advantage of hybrid integration is that it can fully utilize the excellent performance of different material systems.

For example, the optical chip 400 may be a III-V/Si hybrid integrated optical chip. In the III-V/Si hybrid integrated optical chip, the growth material system for the optical modulator is a III-V semiconductor material. As direct band gap semiconductor materials, III-V materials have strong quantum well-confined stark effect. By controlling changes in the applied electric field, carrier variation is induced, thereby causing a change in refractive index to implement optical signal modulation. The growth material system for devices such as the beam splitters, the beam combiners, the frequency mixers, and the photodetectors is Si-based material. In some embodiments, the III-V/Si hybrid integrated optical chip may be an InP/Si hybrid integrated optical chip.

For example, the optical chip 400 may be a thin-film lithium niobate/Si hybrid integrated optical chip. Compared with the III-V/Si hybrid integrated optical chip, the optical modulator in the thin-film lithium niobate/Si hybrid integrated optical chip is a thin-film lithium niobate-based optical modulator.

In some embodiments, the optical chip 400 may be a monolithically integrated silicon photonic chip. Since Si is an indirect band gap semiconductor material with extremely low luminous efficiency, a light source 500 is provided on one side of the optical chip 400. The light emitted from the side surface of the light source 500 is coupled into the optical chip 400. The light emitted by the light source 500 is non-data-carrying light. After the light enters the optical chip 400, the optical chip 400 performs phase modulation on the light to load the electrical signal onto the light, so as to obtain data-carrying light, namely, an optical emission signal, thereby implementing emission of the optical signal.

In some embodiments, the optical chip 400 may be an InP/Si hybrid integrated optical chip. III-V materials are direct band gap semiconductor materials with strong gain characteristics. Therefore, III-V materials have good luminous properties, such as InP lasers. The InP laser is integrated inside the InP/Si hybrid integrated optical chip as the light source.

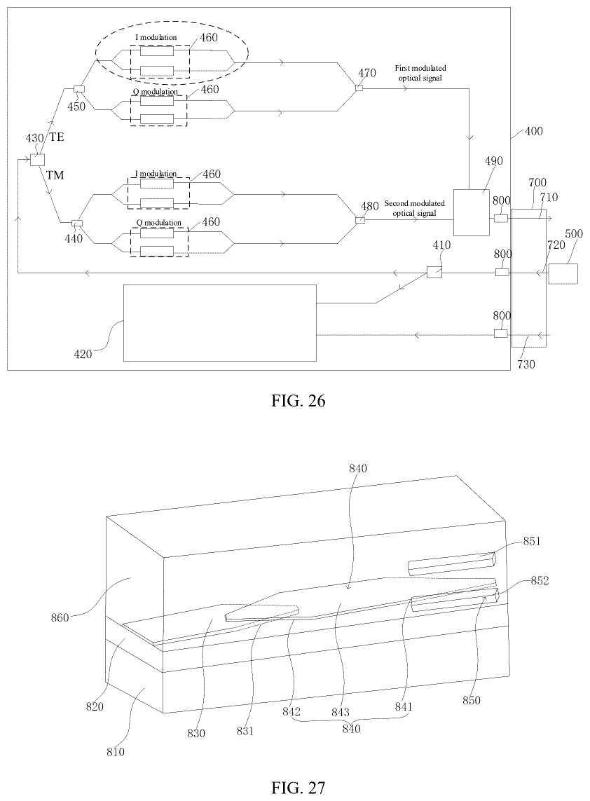

FIG. 26 is a schematic diagram of an internal structure of an optical chip according to some embodiments of the present disclosure. As shown in FIG. 26, in some embodiments, the optical chip 400 may be a monolithically integrated silicon photonic chip.

In some embodiments, the light source 500 is provided outside the optical chip 400. The non-signal-carrying light generated by the light source 500 is coupled into the optical chip 400. The non-signal-carrying light generated by the light source 500 is split into a first beam and a second beam by the beam splitter 410 integrated inside the optical chip 400.

As the local oscillator light, the first beam is coupled into the optical demodulator 420 built into the optical chip 400, and the external optical signal is simultaneously coupled into the optical demodulator 420. The first beam and the external optical signal to be demodulated undergo coherent demodulation in the optical demodulator to demodulate the corresponding electrical signal.

As the light source, the second beam is transmitted into a polarization beam splitter 430, and is split by the polarization beam splitter 430 into two beams with different polarization directions: TE-polarized light and TM-polarized light.

The TE-polarized light is split into two beams by abeam splitter 450, and the two beams are respectively coupled into the two upper optical modulators 460 shown in FIG. 26. In the two optical modulators 460, the upper optical modulator 460 performs I modulation on the received light to generate an I modulation signal, and the lower optical modulator 460 performs Q modulation on the received light to generate a Q modulation signal. The I modulation signal and Q modulation signal of this beam are combined by a multiplexer 470 to generate a first sub-modulated optical signal.

The TM-polarized light is split into two beams by abeam splitter 440, and the two beams are respectively coupled into the two lower optical modulators 460 shown in FIG. 26. In the two optical modulators 460, the upper optical modulator 460 performs I modulation on the received light to generate an I modulation signal, and the lower optical modulator 460 performs Q modulation on the received light to generate a Q modulation signal. The I modulation signal and Q modulation signal of this beam are combined by the multiplexer 480 to generate a second sub-modulated optical signal.

The first sub-modulated optical signal and the second sub-modulated optical signal are respectively input into the multiplexer 490, and combined to generate an optical modulation signal, thereby implementing signal modulation.

In some embodiments, the optical port end of the optical chip 400 includes an optical output port, a first input optical port, and a second input optical port. The optical output port of the optical chip 400 is optically connected to the multiplexer 490, the first optical input port is optically connected to the beam splitter 410, and the second optical input port is optically connected to the optical demodulator 420.

The optical output port of the optical chip 400 is configured to output the optical emission signal modulated and generated by the optical chip 400. The first optical input port is configured to input the non-data-carrying light generated by the light source 500 into the optical chip 400, and the second optical input port is configured to input the external optical signal to be demodulated into the optical chip 400.

In some embodiments, a fiber array 700 is provided outside the optical chip 400. The optical fiber array 700 includes a first optical fiber ribbon 710, a second optical fiber ribbon 720, and a third optical fiber ribbon 730.

In some embodiments, the first optical fiber ribbon 710 is coupled to the optical output port of the optical chip 400. The optical emission signal modulated and generated by the optical chip 400 is output from the optical chip 400 via the optical output port and coupled into the first optical fiber ribbon 710, and then output to the outside of the optical module via the first optical fiber ribbon 710.

In some embodiments, the second optical fiber ribbon 720 is coupled to the first optical input port of the optical chip 400. The non-data-carrying light generated by the light source 500 is transmitted to the first optical input port of the optical chip 400 via the second optical fiber ribbon 720, thus being coupled into the optical chip 400 and the beam splitter 410 for subsequent optical signal modulation.

In some embodiments, the third optical fiber ribbon 730 is coupled to the second optical input port of the optical chip 400. The external optical signal to be demodulated is transmitted to the second optical input port of the optical chip 400 via the third optical fiber ribbon 730, thus being coupled into the optical chip 400 and the optical demodulator 420 for optical signal demodulation.

In some embodiments, the optical emission signal modulated and generated by the optical chip 400 is transmitted to the first optical fiber ribbon 710 via the internal waveguide of the optical chip 400. The light source input into the optical chip 400 by the second optical fiber ribbon 720 is transmitted to the beam splitter 410 via the internal waveguide of the optical chip 400. The optical signal to be demodulated that is input into the optical chip 400 by the third optical fiber ribbon 730 is transmitted to the optical demodulator 420 via the internal waveguide of the optical chip 400.

In some embodiments, the internal waveguide of the optical chip 400 is a silicon-on-insulator (SOI) waveguide. The SOI waveguide sequentially includes, from bottom to top: a substrate, a buried oxide (box) layer, and a top silicon layer. For example, the buried oxide layer is a SiO₂ layer.

The refractive index difference between the top silicon layer and the buried oxide layer is relatively large, thus providing strong confinement for the beam and resulting in a small effective mode field area. The refractive index contrast of the SOI waveguide is greater than that of the optical fiber, so the effective mode field area of the SOI waveguide is smaller than that of the optical fiber. This further leads to mode mismatch between the SOI waveguide and the optical fiber, and large coupling loss when the SOI waveguide and the optical fiber are coupled, thereby reducing the coupling efficiency thereof.

For example, the effective mode field area of a silicon waveguide is usually less than 1 μm², while the effective optical field area of a standard single-mode optical fiber is usually about 70 μm².

In some embodiments of the present disclosure, edge coupling is adopted between the optical chip 400 and the optical fiber. An optical coupler 800 is provided at the optical port end of the optical chip 400. The optical coupler 800 is an edge coupler. The optical coupler 800 serves as a bridge for optical field energy transmission between the SOI waveguide and the optical fiber, and can improve the optical coupling efficiency between the SOI waveguide and the optical fiber.

In some embodiments, the optical coupler 800 is respectively provided at the optical output port, first input optical port, and second optical input port of the optical chip 400.

In some embodiments, an optical coupler 800 is provided between the multiplexer 490 and the first optical fiber ribbon 710 to improve the optical coupling efficiency between the internal SOI waveguide of the optical chip 400 and the first optical fiber ribbon 710.

In some embodiments, another optical coupler 800 is provided between the beam splitter 410 and the second optical fiber ribbon 720 to improve the optical coupling efficiency between the internal SOI waveguide of the optical chip 400 and the second optical fiber ribbon 720.

In some embodiments, another optical coupler 800 is provided between the optical demodulator 420 and the third optical fiber ribbon 730 to improve the optical coupling efficiency between the internal SOI waveguide of the optical chip 400 and the third optical fiber ribbon 730.

FIG. 27 is a first perspective structural diagram of an optical coupler according to some embodiments of the present disclosure. As shown in FIG. 27, in some embodiments, the optical coupler 800 is configured to improve the optical coupling efficiency between the SOI waveguide and the optical fiber. The optical coupler 800 includes a substrate 810 and a buried oxide layer 820. For example, the substrate 810 is a silicon-based substrate.

In some embodiments, the buried oxide layer 820 is a SiO₂ layer. The buried oxide layer 820 is located above the substrate 810. The thickness of the buried oxide layer 820 is less than the thickness of the substrate 810.

In some embodiments, a transmission waveguide 830 is provided above the buried oxide layer 820. The top silicon layer of the SOI wafer is etched by photolithography to obtain the transmission waveguide 830. For example, the transmission waveguide 830 is a silicon waveguide.

In some embodiments, the buried oxide layer 820 is provided between the substrate 810 and the transmission waveguide 830. The refractive index of the buried oxide layer 820 is lower than that of the transmission waveguide 830, and the refractive index difference between the buried oxide layer and the transmission waveguide is relatively large. The transmission waveguide 830 has a strong confinement effect on the optical field, such that the optical field is mainly confined within the transmission waveguide 830 for transmission, reducing transmission loss.

In some embodiments, in order to improve the optical coupling efficiency between the optical chip 400 and the optical fiber ribbon, a coupling waveguide array 850 is provided at the edge of the optical coupler 800. The coupling waveguide array 850 is provided at one end of the optical coupler 800 facing the optical port of the optical fiber chip 400 for optical coupling with the optical fiber array. The coupling waveguide array 850 is provided at the optical port of the optical coupler 800.

In some embodiments, a transition waveguide 840 is formed above the transmission waveguide 830. One end of the transition waveguide 840 faces the coupling waveguide array 850 for optical coupling with the coupling waveguide array 850, and the other end thereof faces the transmission waveguide 830 for optical coupling with the transmission waveguide 830.

In some embodiments, both the coupling waveguide array 850 and the transition waveguide 840 may be silicon nitride waveguides. Silicon nitride has a transparent window in an optical communication band and low temperature sensitivity, and a fabrication process thereof is highly compatible with CMOS. The refractive index of silicon nitride is approximately 1.98, the refractive index of the silicon waveguide is approximately 3.4, and the refractive index of SiO₂ is approximately 1.44. Therefore, the confinement ability of silicon nitride to the optical field is between the confinement ability of the silicon waveguide to the optical field and the confinement ability of the SiO₂ waveguide to the optical field, making it one of the materials used in the design of edge couplers based on waveguides with high refractive index and small cross-sectional size.

In some embodiments, when the coupling waveguide array 850 and the transition waveguide 840 are silicon nitride waveguides, the coupling waveguide array 850 has a same refractive index as the transition waveguide 840. The refractive index of the transition waveguide 840 is lower than the refractive index of the substrate 810, and the refractive index of the transition waveguide 840 is lower than the refractive index of the transmission waveguide 830.

In some embodiments, the coupling waveguide array 850 may be provided at one end of the transition waveguide 840 in various combinations. The coupling waveguide array 850 is provided at one end of the transition waveguide 840 facing the optical fiber array 700.

In some embodiments, the coupling waveguide array 850 includes at least two coupling waveguides. The coupling waveguides are symmetrically distributed with respect to the central axis of the transition waveguide 840. FIG. 27 shows that the coupling waveguide array 850 includes two coupling waveguides: a coupling waveguide 851 and a coupling waveguide 852. The coupling waveguide 851 and the coupling waveguide 852 are respectively located on both sides of the transition waveguide 840.

Since the refractive index of the coupling waveguide 851 and the refractive index of the coupling waveguide 852 are higher than the refractive index of SiO₂, and the coupling waveguide 851 and the coupling waveguide 852 are respectively located on both sides of the transition waveguide 840, better horizontal confinement of the optical field can be implemented, restricting the optical field within the transition waveguide 840, thereby increasing the optical coupling efficiency.

In some embodiments, the coupling waveguide 851 and the coupling waveguide 852 are relatively thin strip-shaped waveguides. The coupling waveguide and the coupling waveguide may also be tapered waveguides.

In some embodiments, a first tapered region 841 is formed at one end of the transition waveguide 840 facing the coupling waveguide array 850, and a second tapered region 842 is formed at one end of the transition waveguide 840 facing the transmission waveguide 830. A flat region 843 is formed between the first tapered region 841 and the second tapered region 842.

The waveguide widths of the first tapered region 841 and the second tapered region 842 exhibit opposite tapering profiles.

In some embodiments, a third tapered region 831 is formed at one end of the transmission waveguide 830 facing the transition waveguide 830. The waveguide widths of the third tapered region 831 and the second tapered region 842 also exhibit opposite tapering profiles.

In some embodiments, along the direction from the coupling waveguide array 850 toward the transmission waveguide 830, the waveguide width of the first tapered region 841 gradually increases, the waveguide width of the second tapered region 842 gradually decreases, and the waveguide width of the third tapered region 831 gradually increases.

In some embodiments, when the second optical fiber ribbon 720 and the third optical fiber ribbon 730 respectively transmit non-data-carrying light output from the light source 500 and external optical signals to be demodulated to the optical chip, the waveguide width of the first tapered region 841 gradually increases along the direction of optical field transmission, such that more optical field is squeezed from the coupling waveguide 851 and the coupling waveguide 852 into the first tapered region 841 of the transition waveguide 840. The optical field continues to propagate into the flat region 843 along the first tapered region 841, the optical field energy is maintained in the flat region 843, and then the optical field continues to propagate into the second tapered region 842. The waveguide width of the second tapered region 842 gradually decreases, and the waveguide width of the third tapered region 831 gradually increases, such that more optical field is squeezed from the second tapered region 842 of the transition waveguide 840 into the transmission waveguide 830, and is coupled into the beam splitter 410 or the optical demodulator 420 via the transmission waveguide 830 for optical signal modulation or demodulation.

In some embodiments, the optical emission signal modulated and generated by the optical chip 400 is output by the multiplexer 490 and transmitted along the transmission waveguide 830. Along the direction of optical field transmission, the waveguide width of the third tapered region 831 gradually decreases, while the waveguide width of the second tapered region 842 gradually increases, such that more optical field is squeezed from the transmission waveguide 830 into the second tapered region 842 of the transition waveguide 840. Then, the optical field propagates into the flat region 843, the optical field energy is maintained in the flat region 843, and the optical field continues to propagate into the first tapered region 841. Along the direction of optical field transmission, the waveguide width of the first tapered region 841 gradually decreases, such that the optical field is squeezed into the coupling waveguide array 850 and coupled into the first optical fiber ribbon 710 via the coupling waveguide array 850 to transmit the optical emission signal to the outside.

As the waveguide width of the first tapered region 841 gradually decreases, the confinement effect of the waveguide on light gradually weakens, and an optical field with a large cross-section is formed at the end of the first tapered region 841 to match the optical field area of the first optical fiber ribbon 710, enabling direct coupling with the first optical fiber ribbon 710, and increasing the optical coupling efficiency between a hybrid waveguide system and the first fiber ribbon.

In some embodiments, the hybrid waveguide system formed by the coupling waveguide array 850 and the transition waveguide 840 can implement efficient coupling with the optical fiber ribbon.

In some embodiments, when the second optical fiber ribbon 720 and the third optical fiber ribbon 730 respectively transmit the non-data-carrying light output from the light source 500 and the external optical signals to be demodulated to the optical chip 400, the optical field is gradually coupled into the transition waveguide 840 along the hybrid waveguide system formed by the coupling waveguide array 850 and the transition waveguide 840, and is gradually coupled into the transmission waveguide 830 with the propagation of the optical field, thereby being transmitted within the optical chip 400 via the transmission waveguide 830.

In some embodiments, the optical emission signal modulated and generated by the optical signal 400 is transmitted within the optical chip 400 along the transmission waveguide 830. The optical field is gradually coupled into the transition waveguide 840 with the propagation thereof, and then coupled into the hybrid waveguide system formed by the coupling waveguide array 850 and the transition waveguide 840 until the optical field is coupled into the first optical fiber ribbon 710, and the optical emission signal is transmitted to the outside of the optical module via the first optical fiber ribbon 710.

In some embodiments, the transition waveguide 840 and the transmission waveguide 830 are provided adjacent to each other longitudinally to improve the coupling efficiency between the transition waveguide and the transmission waveguide. For example, a longitudinal gap between the transition waveguide 840 and the transmission waveguide 830 is relatively small.

In some embodiments, the transmission waveguide 830 and the substrate 810 are separated by the buried oxide layer 820. When the buried oxide layer 820 is relatively thin, the transmission waveguide 830 is relatively close to the substrate 810. Since the transition waveguide 840 is relatively close to the transmission waveguide 830, the transition waveguide 840 is also relatively close to the substrate 810.

In some embodiments, the coupling waveguide array 850 and the transition waveguide 840 have the same refractive index, and for example, both the coupling waveguide array and the transition waveguide are silicon nitride waveguides. When the transition waveguide 840 is close to the substrate 810 and the refractive index of the transition waveguide 840 is lower than that of the substrate 810, the optical field may leak toward the substrate 810 during coupling between the hybrid waveguide system formed by the coupling waveguide array 850 and the transition waveguide 840 and the transition waveguide 840.

In some embodiments, when the transmission waveguide 830 and the transition waveguide 840 are close to the substrate, the leakage of the optical field toward the substrate 810 is reduced during coupling between the transition waveguide 840 and the transmission waveguide 830 because the refractive index of the transition waveguide 840 is lower than that of the transmission waveguide 830. It can be understood that when the thickness of the buried oxide layer 820 is further reduced, the optical field may also leak toward the substrate 810 during coupling between the transition waveguide 840 and the transmission waveguide 830.

In some embodiments, SOI silicon wafers are used to fabricate SOI waveguides. For example, silicon on the top surface of the SOI silicon wafer is etched by photolithography to obtain the transmission waveguide 830. For example, the etching performance of the surface of a 12-inch SOI silicon wafer is better than that of an 8-inch SOI silicon wafer. The thickness of the buried oxide layer in the 12-inch SOI silicon wafer is 2 μm, while that in the 8-inch SOI silicon wafer is 3 μm. Therefore, during the use of the 12-inch SOI silicon wafer, the 2 μm thickness of the buried oxide layer will cause the optical field to leak toward the substrate 810 during coupling between the hybrid waveguide system and the transition waveguide 840.

In some embodiments, a high refractive index region 860 is formed above the buried oxide layer 820. The high refractive index region 860 encapsulates the transmission waveguide 830, the coupling waveguide array 850, and the transition waveguide 840. For example, the substrate 810, the buried oxide layer 820, and the high refractive index region 860 are stacked from bottom to top.

In some embodiments, the high refractive index region 860 includes a region with a refractive index higher than that of the buried oxide layer 820. For example, the refractive index of the buried oxide layer 820 is constant.

Based on the characteristic that the optical field tends to propagate toward the region with a high refractive index, the high refractive index region 860 is located above the buried oxide layer 820, and the high refractive index region 860 includes the region with a refractive index higher than that of the buried oxide layer 820. Under the effect of the refractive index difference between the high refractive index region 860 and the buried oxide layer 820, the optical field inside the optical chip gradually propagates upward, and is elevated, thereby increasing a distance between the optical field and the substrate 810, reducing leakage of the optical field into the substrate 810, and improving optical coupling efficiency.

In some embodiments, the high refractive index region 860 shown in FIG. 27 is a region with a uniform refractive index, and the refractive index of the entire high refractive index region 860 is higher than that of the buried oxide layer 820. The transmission waveguide 830, the transition waveguide 840, and the coupling waveguide array 850 are encapsulated within the high refractive index region 860.

In some embodiments, the buried oxide layer 820 is a SiO₂ layer. The high refractive index region 860 is a SiO₂ region. The refractive index of the SiO₂ dielectric in the high refractive index region 860 is higher than the refractive index of the SiO₂ dielectric in the buried oxide layer 820. SiO₂ dielectrics with different refractive indices are stacked together, and the refractive index difference between the SiO₂ dielectrics with different refractive indices can provide better vertical confinement of the optical field, keeping the optical field away from the substrate 810, thereby reducing optical leakage loss to the substrate 810.

In some embodiments, the refractive index of the SiO₂ dielectric can be changed by changing the deposition rate, gas ratio, and gas flow during the SiO₂ fabrication process.

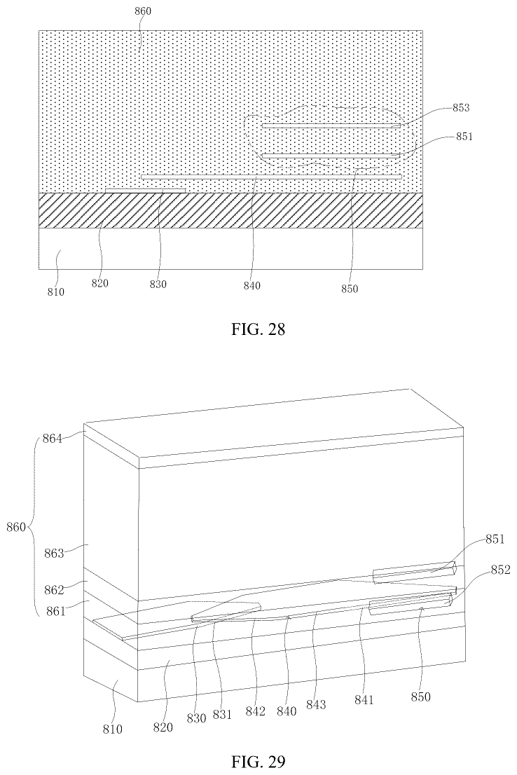

FIG. 28 is a first cross-sectional structural diagram of an optical coupler according to some embodiments of the present disclosure. As shown in FIG. 28, in some embodiments, the substrate 810, the buried oxide layer 820, and the high refractive index region 860 are sequentially stacked. The transmission waveguide 830, the transition waveguide 840, and the coupling waveguide array 850 are encapsulated within the high refractive index region 860.

In some embodiments, the high refractive index region 860 is a region with a uniform refractive index, the refractive index of the high refractive index region 860 is higher than that of the buried oxide layer 820, thereby providing better longitudinal confinement of the optical field, elevating the optical field away from the substrate 810, and reducing optical leakage loss to the substrate 810.

In some embodiments, the total thickness of the high refractive index region 860 is limited by the effective optical field area of the optical fiber. The thickness of the high refractive index region 860 determines the maximum optical field size of the optical coupler 800; therefore, the high refractive index region 860 has a predetermined thickness, such that the effective optical field area of the transmission waveguide 830 matches that of the optical fiber array 700.

In some embodiments, the coupling waveguide array 850 includes the coupling waveguide 851 and the coupling waveguide 853. The coupling waveguide 851 and the coupling waveguide 853 are arranged longitudinally, and both located on one side of the transition waveguide 840. Coupling waveguides symmetrically arranged with respect to the coupling waveguide 851 and the coupling waveguide 853 respectively are arranged on the other side of the transition waveguide 840.

In some embodiments, no limitation is imposed on the relative positional relationship among the coupling waveguide 851, the coupling waveguide 853, and the transition waveguide 840. For example, the coupling waveguide 851 and the coupling waveguide 853 may both be located above the transition waveguide 840. For example, the coupling waveguide 851 and the coupling waveguide 853 may be located above and below the transition waveguide 840, respectively.

FIG. 29 is a second perspective structural diagram of an optical coupler according to some embodiments of the present disclosure. As shown in FIG. 29, in some embodiments, the substrate 810, the buried oxide layer 820, and the high refractive index region 860 are sequentially stacked. The transmission waveguide 830, the transition waveguide 840, and the coupling waveguide array 850 are encapsulated within the high refractive index region 860.

In some embodiments, the high refractive index region 860 includes multiple sublayers with different refractive indices, and the refractive index of at least one sublayer is higher than that of the buried oxide layer 820.

In some embodiments, sublayers with different refractive indices are stacked to form the high refractive index region 860. Furthermore, the refractive index of at least one sublayer within the high refractive index region 860 is higher than that of the buried oxide layer 820.

In some embodiments, taking the example where the high refractive index region 860 includes four sublayers with different refractive indices, the high refractive index region 860 includes a first refractive index layer 861, a second refractive index layer 862, a third refractive index layer 863, and a fourth refractive index layer 864.

The first refractive index layer 861, the second refractive index layer 862, the third refractive index layer 863, and the fourth refractive index layer 864 are sequentially stacked from bottom to top.

In some embodiments, the first refractive index layer 861, the second refractive index layer 862, the third refractive index layer 863, and the fourth refractive index layer 864 each have different refractive indices.

For example, the first refractive index layer 861, the second refractive index layer 862, the third refractive index layer 863, and the fourth refractive index layer 864 are SiO₂ layers with different refractive indices, that is, the dielectrics of each layer are all SiO₂. As described above, the refractive index of SiO₂ can be changed by changing the deposition rate, gas ratio, and gas flow during the SiO₂ fabrication process.

For example, the dielectrics of the first refractive index layer 861, the second refractive index layer 862, the third refractive index layer 863, and the fourth refractive index layer 864 may be SiO₂ or may be non-SiO₂, provided that the refractive index of the dielectric satisfies the requirement: the refractive index of at least one layer being higher than that of the buried oxide layer 820.

In some embodiments, the refractive index of at least one of the first refractive index layer 861, the second refractive index layer 862, the third refractive index layer 863, and the fourth refractive index layer 864 is higher than that of the buried oxide layer 820, so as to elevate the optical field away from the substrate 810 and reduce leakage of the optical field into the substrate 810.

For example, the refractive index of the first refractive index layer 861 is higher than that of the buried oxide layer 820. The refractive indices of the second refractive index layer 862, the third refractive index layer 863, and the fourth refractive index layer 864 may be higher than or lower than that of the buried oxide layer 820.

For example, the refractive index of the third refractive index layer 863 is higher than that of the buried oxide layer 820. The refractive indices of the first refractive index layer 861, the second refractive index layer 862, and the fourth refractive index layer 864 may be higher than or lower than that of the buried oxide layer 820.

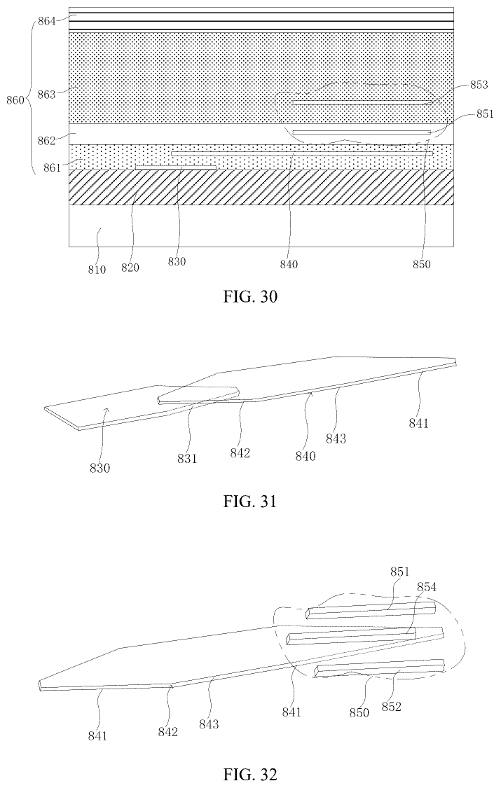

FIG. 30 is a second cross-sectional structural diagram of an optical coupler according to some embodiments of the present disclosure. As shown in FIG. 30, in some embodiments, the substrate 810, the buried oxide layer 820, the first refractive index layer 861, the second refractive index layer 862, the third refractive index layer 863, and the fourth refractive index layer 864 are sequentially stacked from bottom to top.

In some embodiments, taking the example where the refractive index of the third refractive index layer 863 is higher than that of the buried oxide layer 820, the refractive index of the third refractive index layer 863 is higher than that of the buried oxide layer 820, so as to elevate the optical field away from the substrate 810 and reduce leakage of the optical field into the substrate 810.

In some embodiments, the total thickness of the high refractive index region 860 is limited by the effective optical field area of the optical fiber. The high refractive index region 860 has a predetermined thickness such that the effective optical field area of the transmission waveguide 830 matches that of the optical fiber array 700.

In some embodiments, taking the example where the refractive index of the third refractive index layer 863 is higher than that of the buried oxide layer 820, the thickness of the third refractive index layer 863 with the highest refractive index determines the maximum optical field size of the optical coupler 800. To implement efficient coupling with the optical fiber, the thickness of the third refractive index layer 863 should be as large as possible. Therefore, in design trade-off, the number of sublayers with different refractive indices should not be excessive, so as to avoid the thickness of the third refractive index layer 863 being too small.

In some embodiments, taking the example where the refractive index of the third refractive index layer 863 is higher than that of the buried oxide layer 820, the thickness of the third refractive index layer 863 is greater than the thicknesses of the first refractive index layer 861, the second refractive index layer 862, and the fourth refractive index layer 864.

FIG. 31 is an assembly diagram between a transmission waveguide and a transition waveguide according to some embodiments of the present disclosure. As shown in FIG. 31, in some embodiments, a first tapered region 841 is formed at one end of the transition waveguide 840 facing the coupling waveguide array 850, and a second tapered region 842 is formed at one end of the transition waveguide 840 facing the transmission waveguide 830. A flat region 843 is formed between the first tapered region 841 and the second tapered region 842.

The waveguide widths of the first tapered region 841 and the second tapered region 842 exhibit opposite tapering profiles.

In some embodiments, a third tapered region 831 is formed at one end of the transmission waveguide 830 facing the transition waveguide 830. The waveguide widths of the third tapered region 831 and the second tapered region 842 also exhibit opposite tapering profiles.

Along the direction of optical field transmission, the first tapered region 841 and the third tapered region 831 have opposite tapering trends, which facilitates coupling between the transition waveguide 840 and the transmission waveguide 830 and improves coupling efficiency.

FIG. 32 is an assembly diagram between a transition waveguide and a coupling waveguide array according to some embodiments of the present disclosure. As shown in FIG. 32, in some embodiments, the coupling waveguide array 850 is located at one end where the first tapered region 841 is situated.

In some embodiments, the coupling waveguide array 850 includes the coupling waveguide 851, the coupling waveguide 852, and the coupling waveguide 854. The coupling waveguide 854 is located above the first tapered region 841, while the coupling waveguide 851 and the coupling waveguide 852 are respectively located on both sides of the first tapered region 841. The coupling waveguide 851 and the coupling waveguide 852 are symmetrically arranged with respect to the central axis of the first tapered region 841.

In some embodiments, the coupling waveguide array 850 is encapsulated within the high refractive index region 860. The largest refractive index region within the high refractive index region 860 is still lower than the refractive index of the coupling waveguide array 850. Therefore, when the coupling waveguide 851 and the coupling waveguide 852 are respectively located on both sides of the first tapered region 841, they can provide better horizontal confinement of the optical field.

Based on the optical coupler provided in the above embodiments, the present disclosure further provides a method for fabricating an optical coupler, and the method is used to fabricate the optical coupler. The method for fabricating an optical coupler includes:
S110: Etch a top silicon layer on a surface of an SOI wafer to form a transmission waveguide, where the SOI wafer includes a substrate, a buried oxide layer, and a top silicon layer from bottom to top.

In some embodiments, the top silicon layer of the SOI wafer is etched by photolithography to obtain a transmission waveguide 830.
S120: Form a transition waveguide 840 above one end of the transmission waveguide.

In some embodiments, in order to improve the coupling efficiency between the transmission waveguide 830 and the transition waveguide 840, the longitudinal gap between the transmission waveguide and the transition waveguide is relatively small.
S130: Form a coupling waveguide array at one end of the transition waveguide.

In some embodiments, the coupling waveguide array 850 is located at an edge position of the optical coupler.
S140: Epitaxially grow a high refractive index region with a uniform refractive index higher than that of the buried oxide layer upward along the buried oxide layer; or epitaxially grow all sublayers with different refractive indices upward along the buried oxide layer, where the refractive index of at least one sublayer is higher than that of the buried oxide layer.

In some embodiments, the transmission waveguide 830 and the substrate 810 are separated by the buried oxide layer 820. When the buried oxide layer 820 is relatively thin, the transmission waveguide 830 is relatively close to the substrate 810. Since the transition waveguide 840 is relatively close to the transmission waveguide 830, the transition waveguide 840 is also relatively close to the substrate 810.

In some embodiments, the coupling waveguide array 850 and the transition waveguide 840 have the same refractive index, and for example, both the coupling waveguide array and the transition waveguide are silicon nitride waveguides. When the transition waveguide 840 is close to the substrate 810 and the refractive index of the transition waveguide 840 is lower than that of the substrate 810, the optical field may leak toward the substrate 810 during coupling between the hybrid waveguide system formed by the coupling waveguide array 850 and the transition waveguide 840 and the transition waveguide 840.

In some embodiments, if the high refractive index region 860 includes the region with a refractive index higher than that of the buried oxide layer 820. Under the effect of the refractive index difference between the high refractive index region 860 and the buried oxide layer 820, the optical field inside the optical chip gradually propagates upward, and is elevated, thereby increasing a distance between the optical field and the substrate 810, reducing leakage of the optical field into the substrate 810, and improving optical coupling efficiency.

In the optical coupler provided by the present disclosure, the substrate, the buried oxide layer, and the high refractive index region are sequentially stacked. The high refractive index region encapsulates the transmission waveguide, the coupling waveguide array, and the transition waveguide. The high refractive index region includes a region with a refractive index higher than that of the buried oxide layer. For example, when the high refractive index region is a region with a uniform refractive index, the refractive index of the high refractive index region is higher than that of the buried oxide layer; or, when the high refractive index region includes multiple sublayers with different refractive indices, the refractive index of at least one sublayer is higher than that of the buried oxide layer. Based on the characteristic that the optical field tends to propagate toward the region with a high refractive index, the high refractive index region is located above the buried oxide layer, and the high refractive index region includes the region with a refractive index higher than that of the buried oxide layer. Under the effect of the refractive index difference between the high refractive index region and the buried oxide layer, the optical field inside the optical chip gradually propagates upward and is elevated, thereby increasing a distance between the optical field and the substrate, reducing leakage of the optical field into the substrate, and improving optical coupling efficiency.

The polarization beam splitter in the above embodiments may be a polarization rotator-splitter, to implement polarization rotation and beam splitting of polarization-multiplexed beams. The specific structure of the polarization rotator-splitter can be understood with reference to the following descriptions.

With reference to FIG. 14, in some embodiments, the light source 500 is provided at a side of the optical chip 400, and the light emitted from the side surface of the light source 500 is coupled into the optical chip 400. The light source 500 serves as an external light source for the optical chip 400, and the light emitted by the light source 500 enters the optical chip 400. The light source 500 may be a laser box, in which a laser is encapsulated. The laser emits light to generate a laser beam, and the light source 500 is used to provide the emitted laser to the optical chip 400. Laser has become the preferred light source for optical modules and even optical fiber transmission due to its excellent single-wavelength characteristics and optimal wavelength tuning characteristics. Other types of light, such as LED light, are generally not adopted in common optical communication systems. Even if such light sources are used in special optical communication systems, their characteristics and chip components differ significantly from those of lasers, resulting in substantial technical differences between optical modules using lasers and optical modules using other light sources. Those skilled in the art generally would not consider these two types of optical modules to be technically interchangeable.

The light emitted by the light source 500 is the non-data-carrying light. After the light enters the optical chip 400, the optical chip 400 performs phase modulation on the light to load the electrical signal onto it, so as to obtain data-carrying light, namely, an optical emission signal, thereby achieving emission of the optical signal.

In some embodiments, the optical chip 400 may be a silicon photonic chip, that is, the optical chip 400 is formed by packaging with a silicon material. The silicon photonic chip includes a Mach-Zehnder modulator (MZM), within which a silicon photonic phase modulator is integrated. The silicon photonic phase modulator is configured to modulate and demodulate optical signals.

In some embodiments, the optical chip 400 may be a thin-film lithium niobate chip, that is, the optical chip 400 is formed by packaging with a thin-film lithium niobate material. Thin-film lithium niobate exhibits the linear electro-optic effect and other characteristics, and an applied electric field causes a linear change in the refractive index in the corresponding direction, such that the light wave transmitted in the dielectric has controllable intensity, phase, and other information. Therefore, thin-film lithium niobate may be selected as the material for the optical modulator, thereby implementing a high modulation rate and other performance advantages.

In some embodiments, the optical chip 400 may be a hybrid InP/Si optical chip, that is, the hybrid InP/Si optical chip is formed by hybrid packaging with an InP material and the silicon material. The hybrid InP/Si optical chip can be combined with the performance of the InP material and the performance of the Si material, enabling the optical chip 400 to have excellent performance and facilitating the increase of the bandwidth of the optical chip 400.

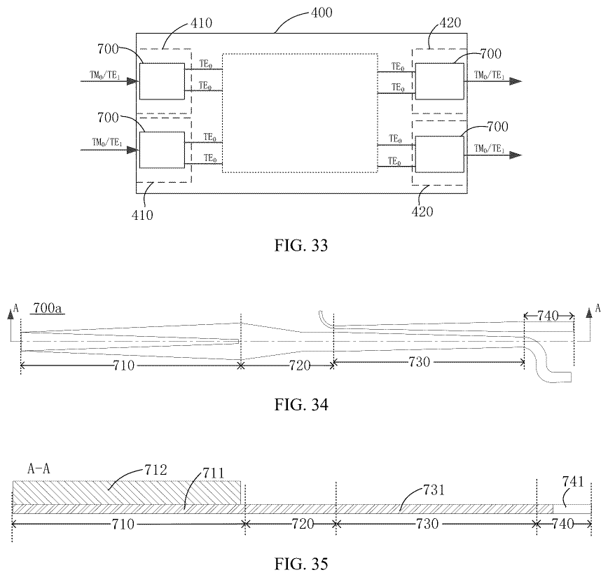

FIG. 33 is a schematic structural diagram of an optical chip according to some embodiments of the present disclosure. As shown in FIG. 33, an optical input port 410 is provided at one side of the optical chip 400, and the polarization rotator-splitter 700 is provided within the optical input port 410. The polarization-multiplexed beam is coupled into the polarization rotator-splitter 700 through the optical input port 410, and the polarization rotator-splitter 700 splits the polarization-multiplexed beam and transmits the split beams into the optical chip 400. For example, the polarization-multiplexed beam includes TM₀ polarized light and TE₀ polarized light. The polarization rotator-splitter 700 splits the polarization-multiplexed beam into two TE₀ polarized beams.

In some embodiments, one or more optical input ports 410 may be provided for the optical chip 400, such as two, three, and four.

In some embodiments, an optical output port 420 is provided at the other side of the optical chip 400, and the polarization rotator-splitter 700 may be provided within the optical output port 420. For example, the direction of the polarization rotator-splitter 700 provided within the optical output port 420 is opposite to that of the polarization rotator-splitter 700 provided within the optical input port 410, such that the polarization rotator-splitter 700 in the optical output port 420 is configured to implement polarization multiplexing of the beam, so as to implement polarization multiplexing of two polarized beams into one polarized beam. For example, two TE₀ polarized beams are polarization-multiplexed into one beam including TM₀ polarized light and TE₀ polarized light.

In some embodiments, one or more optical output ports 420 may be provided for the optical chip 400, such as two, three, and four.

In some embodiments, the optical input port 410 and the optical output port 420 may be provided on a same side or adjacent sides of the optical chip 400.

In some embodiments, the optical input port 410 is coupled to the light source 500 or to an external optical fiber of the optical module. When the optical input port 410 is coupled to the light source 500, the polarization rotator-splitter 700 within the optical input port 410 splits a signal-free beam; and when the optical input port 410 is coupled to an external optical fiber of the optical module, the polarization rotator-splitter 700 within the optical input port 410 splits a signal-carrying beam.

In some embodiments, the optical output port 420 is configured to output the optical signal modulated by the optical chip 400, and the polarization rotator-splitter 700 in the optical output port 420 is configured to output the signal-carrying beam.

FIG. 34 is a first schematic structural diagram of a polarization rotator-splitter according to some embodiments of the present disclosure. FIG. 35 is a cross-sectional view in an A-A direction in FIG. 34. FIG. 34 and FIG. 35 show structures of a polarization rotator-splitter. The polarization rotator-splitter provided in the embodiments of the present disclosure is not limited to the structures shown in FIG. 34 and FIG. 35. The following provides a detailed description of the polarization rotator-splitter 700 provided in the embodiments of the present disclosure with reference to FIG. 34, FIG. 35, and other accompanying drawings.

In some embodiments, the polarization rotator-splitter 700 includes a mode conversion portion 710 in which a tapered waveguide structure is formed. The mode conversion portion 710 is configured to convert the TM₀ polarized light into the TE₁ polarized light.

In some embodiments, the mode conversion portion 710 includes a first waveguide 711 and a second waveguide 712. The first waveguide 711 is provided below the second waveguide 712, and the bottom of the second waveguide 712 is connected to the first waveguide 711. The thickness of the second waveguide 712 is greater than that of the first waveguide 711. For example, the first waveguide 711 and the second waveguide 712 form an irregular ridge waveguide structure.

A polarization-multiplexed beam including the TM₀ polarized light and the TE₀ polarized light is coupled into the mode conversion portion 710 from one end of the mode conversion portion 710. For example, one end of the second waveguide 712 serves as the coupling end for the polarization-multiplexed beam, that is, the polarization-multiplexed beam is input from one end of the second waveguide 712. During transmission, the polarization-multiplexed beam is gradually coupled from the second waveguide 712 into the first waveguide 711, and the TM₀ polarized light undergoes mode hybridization and is converted into the TE₁ polarized light during propagation.

FIG. 36 is a first partial enlarged view of a polarization rotator-splitter according to some embodiments of the present disclosure. As shown in FIG. 36, in some embodiments, the second waveguide 712 is located at the central top of the first waveguide 711. Of course, the embodiments of the present disclosure are not limited to providing the second waveguide 712 at the central top of the first waveguide 711. Of course, the embodiments of the present disclosure are not limited to providing the second waveguide 712 above the first waveguide 711; and the second waveguide may also be provided below the first waveguide 711.

In some embodiments, the width of one end of the first waveguide 711 is less than the width of the other end of the first waveguide 711. For example, the first waveguide 711 is a tapered waveguide.

In some embodiments, the width of one end of the second waveguide 712 is greater than the width of the other end of the second waveguide 712. For example, the second waveguide 712 is a tapered waveguide.

In some embodiments, the width of one end of the second waveguide 712 is greater than or equal to the width of one end of the first waveguide 711, and the width of the second waveguide 712 is less than the width at the other end of the first waveguide 711.

In some embodiments, the width of one end of the first waveguide 711 is greater than or equal to 0.7 μm, and the width of the other end of the first waveguide 711 is less than or equal to 2 μm. For example, the width of one end of the first waveguide 711 is 0.8 μm, and the width of the other end of the first waveguide 711 is 2 μm.

In some embodiments, the width of one end of the second waveguide 712 is less than or equal to 0.7 μm, and the width of the other end of the second waveguide 712 is less than or equal to 0.1 μm. For example, the width of one end of the second waveguide 712 is 0.7 μm, and the width of the other end of the second waveguide 712 is 0.05 μm.

In some embodiments, the polarization rotator-splitter 700 includes a connecting portion 720. One end of the connecting portion 720 is connected to the other end of the mode conversion portion 710, and the connecting portion 720 is configured to interface with the other end of the mode conversion portion 710. For example, one end of the connecting portion 720 is connected to the other end of the first waveguide 711.

In some embodiments, the width of one end of the connecting portion 720 is greater than the width of the other end of the connecting portion 720. For example, the connecting portion 720 is a tapered waveguide.

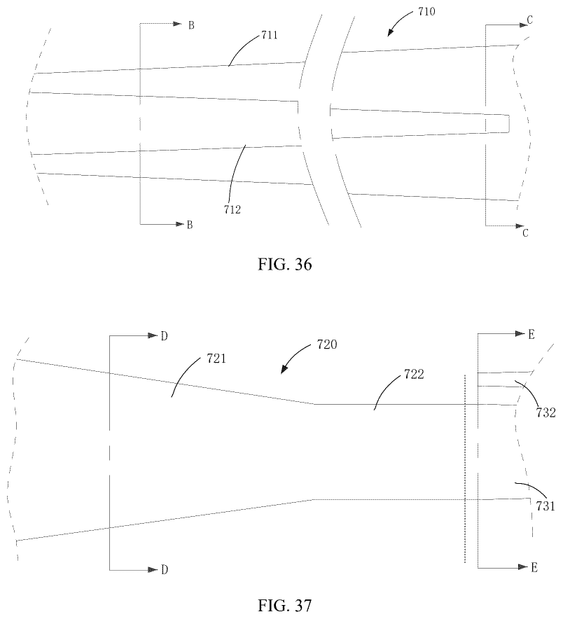

FIG. 37 is a second partial enlarged view of a polarization rotator-splitter according to some embodiments of the present disclosure. As shown in FIG. 37, in some embodiments, the connecting portion 720 includes a tapered waveguide 721 and a straight optical waveguide 722, one end of the tapered waveguide 721 is connected to the other end of the first waveguide 711, and the other end of the tapered waveguide 721 is connected to one end of the straight optical waveguide 722. The width of one end of the tapered waveguide 721 is greater than the width of the other end of the tapered waveguide 721. The tapered waveguide 721 is configured to adaptively adjust the width of the connecting portion. The straight optical waveguide 722 is provided in the connecting portion 720, the straight optical waveguide 722 is configured to reduce the reverse coupling of the beam from the other end of the tapered waveguide 721 into the tapered waveguide 721.

In some embodiments, the polarization rotator-splitter 700 includes a mode coupling portion 730, and the mode coupling portion 730 splits the TE₁ polarized light and the TE₀ polarized light using the mode coupling effect and converts the TE₁ polarized light into the TE₀ polarized light.

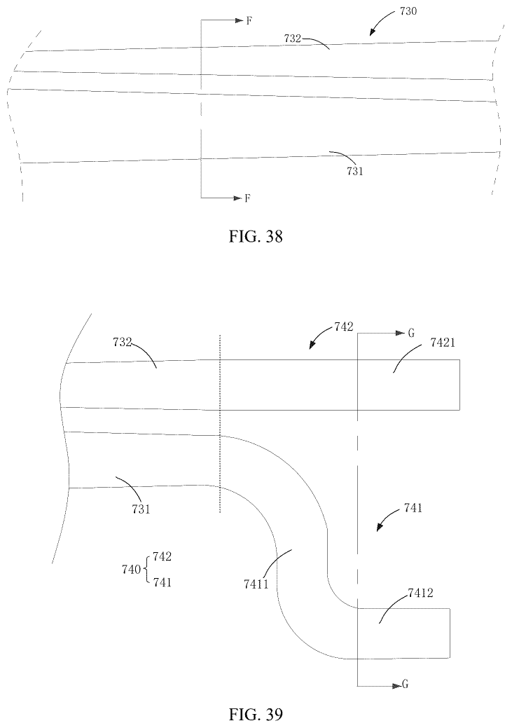

FIG. 38 is a third partial enlarged view of a polarization rotator-splitter according to some embodiments of the present disclosure. As shown in FIG. 38, in some embodiments, the mode coupling portion 730 includes a first coupling waveguide 731 and a second coupling waveguide 732, one end of the first coupling waveguide 731 is connected to the other end of the connecting portion 720, the second coupling waveguide 732 is located at the side of the first coupling waveguide 731, and a gap is provided between the first coupling waveguide 731 and the second coupling waveguide 732. For example, in the direction shown in FIG. 38, the second coupling waveguide 732 is located on the upper side of the first coupling waveguide 731, and a gap is provided between the upper side of the first coupling waveguide 731 and the upper side of the second coupling waveguide 732. Of course, in the embodiments of the present disclosure, the second coupling waveguide 732 may also be located on the lower side of the first coupling waveguide 731. In the embodiments of the present disclosure, the first coupling waveguide 731 and the second coupling waveguide 732 generate a mode coupling effect, such that the TE₁ polarized light output from the connecting portion 720 is coupled into the second coupling waveguide 732 and converted into the TE₀ polarized light, and the TE₀ polarized light output from the connecting portion 720 continues to propagate along the first coupling waveguide 731, thus implementing beam splitting of the TE₁ polarized light and the TE₀ polarized light.

In some embodiments, the width of one end of the first coupling waveguide 731 is greater than the width of the other end of the first coupling waveguide 731. For example, the first coupling waveguide 731 is a tapered waveguide, such as a symmetric tapered waveguide or an asymmetric tapered waveguide.

In some embodiments, the width of one end of the second coupling waveguide 732 is less than the width of the other end of the second coupling waveguide 732. For example, the second coupling waveguide 732 is a tapered waveguide, such as a symmetric tapered waveguide or an asymmetric tapered waveguide.

In some embodiments, the width of one end of the first coupling waveguide 731 is greater than the width of the other end of the second coupling waveguide 732, and the width of the other end of the first coupling waveguide 731 is greater than the width of one end of the second coupling waveguide 732.

In some embodiments, the polarization rotator-splitter 700 includes a beam splitting portion 740, one end of the beam splitting portion 740 is connected to the mode coupling portion 730, and the beam splitting portion 740 is configured to split and transmit two beams of the TE₀ polarized light output by the mode coupling portion 730. The beam splitting portion 740 is configured to facilitate splitting and output of two beams of TE₀ polarized light by the polarization rotator-splitter 700.

FIG. 39 is a fourth partial enlarged view of a polarization rotator-splitter according to some embodiments of the present disclosure. As shown in FIG. 39, in some embodiments, the beam splitting portion 740 includes a third waveguide 741 and a fourth waveguide 742, one end of the third waveguide 741 is connected to the other end of the first coupling waveguide 731, and one end of the fourth waveguide 742 is connected to the other end of the second coupling waveguide 732. The third waveguide 741 serves as one output port of the polarization rotator-splitter 700, and is configured to output one beam of TE₀ polarized light. The fourth waveguide 742 serves as another output port of the polarization rotator-splitter 700, and is configured to output another beam of TE₀ polarized light. A gap is provided between the third waveguide 741 and the fourth waveguide 742, and the width of the other end of the gap is greater than the width of one end of the gap. This helps to effectively reduce coupling between the two beams of TE₀ polarized light when the other ends of the third waveguide 741 and the fourth waveguide 742 are close to each other, thereby facilitating reduction of crosstalk between the two beams of TE₀ polarized light at the output end of the polarization rotator-splitter 700.

In some embodiments, the third waveguide 741 includes an epitaxial waveguide 7411, one end of the epitaxial waveguide 7411 is connected to the other end of the first coupling waveguide 731, and the epitaxial waveguide 7411 extends in a direction away from the center line of the other end of the first coupling waveguide 731. For example, the epitaxial waveguide 7411 extends in a direction away from the second coupling waveguide 732, so as to facilitate adjustment of the gap between the third waveguide 741 and the fourth waveguide 742.

In some embodiments, the third waveguide 741 includes a first straight optical waveguide 7412, and the first straight optical waveguide 7412 is located at the end of the third waveguide 741, facilitating coupling connection between the third waveguide 741 and other structures. For example, one end of the first straight optical waveguide 7412 is connected to the other end of the epitaxial waveguide 7411, and a smooth transition from the other end of the first coupling waveguide 731 to one end of the first straight optical waveguide 7412 can be implemented by the epitaxial waveguide 7411, such that the gap between the third waveguide 741 and the fourth waveguide 742 gradually increases.

In some embodiments, the epitaxial waveguide 7411 is a Bessel curved waveguide, an Euler curved waveguide, an arc waveguide, or the like, such that the epitaxial waveguide 7411 extends smoothly, effectively reducing sharp points on the epitaxial waveguide 7411 that could cause beam reflection loss.

In some embodiments, the fourth waveguide 742 includes a second straight optical waveguide 7421, and one end of the second straight optical waveguide 7421 is connected to the other end of the second coupling waveguide 732. The second straight optical waveguide 7421 is located at the end of the fourth waveguide 742 and is configured to facilitate coupling connection between the fourth waveguide 742 and other structures.

In some embodiments, one end of the epitaxial waveguide 7411 is close to the second straight optical waveguide 7421, and the other end of the epitaxial waveguide 7411 is away from the second straight optical waveguide 7421.

In some embodiments, the fourth waveguide 742 may include the epitaxial waveguide, one end of the epitaxial waveguide is connected to the other end of the second coupling waveguide 732, and the epitaxial waveguide extends in a direction away from the center line of the other end of the second coupling waveguide 732. For example, the epitaxial waveguide extends in a direction away from the first coupling waveguide 732, so as to facilitate adjustment of the gap between the third waveguide 741 and the fourth waveguide 742.

In some embodiments, the mode conversion portion 710, the connecting portion 720, the mode coupling portion 730, and the beam splitting portion 740 form a beam splitting waveguide layer 700a.

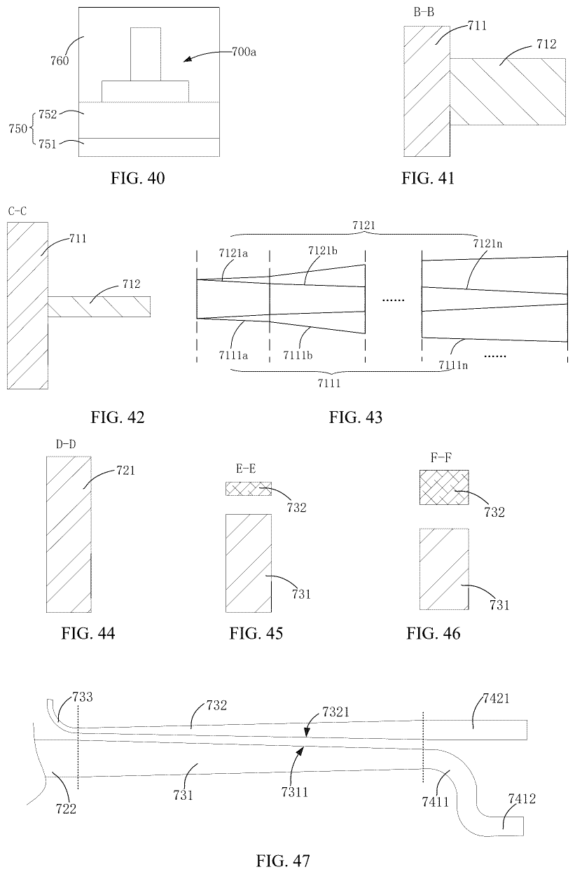

FIG. 40 is a second schematic structural diagram of a polarization rotator-splitter according to some embodiments of the present disclosure. As shown in FIG. 40, the polarization rotator-splitter 700 includes a substrate 750, and the beam splitting waveguide layer 700a is provided on the substrate 750.

In some embodiments, the substrate 750 includes a first substrate layer 751 and a second substrate layer 752, the second substrate layer 752 is provided on the first substrate layer 751, and the beam splitting waveguide layer 700a is provided on the second substrate layer 752.

In some embodiments, the polarization rotator-splitter 700 includes a cladding layer 760, the cladding layer 760 encapsulates sides of the beam splitting waveguide layer 700a.

In some embodiments, the structure of the beam splitting waveguide layer 700a may be made of Si, SiN, InP, lithium niobate (LiNbO₃), and other materials. The first substrate layer 751 may be made of Si and other materials, the second substrate layer 752 may be made of SiO₂ and other materials, and the cladding layer 760 may be made of SiO₂ and other materials.

FIG. 41 is a cross-sectional view in a B-B direction in FIG. 36; FIG. 42 is a cross-sectional view in a C-C direction in FIG. 36; and FIG. 41 and FIG. 42 shows a cross-sectional state of a mode conversion portion. As shown in FIG. 41 and FIG. 42, the first waveguide 711 is a continuous symmetric tapered waveguide, and the second waveguide 712 is a continuous symmetric tapered waveguide, that is, both the first waveguide 711 and the second waveguide 712 change uniformly. Of course, the embodiments of the present disclosure are not limited thereto. In some embodiments, the mode conversion portion 710 is an axisymmetric structure.

FIG. 43 is a schematic structural diagram of a mode conversion portion according to some embodiments of the present disclosure. As shown in FIG. 43, the first waveguide 711 includes multiple segments of first tapered waveguides 7111 sequentially connected, and the width of one end of the first tapered waveguide 7111 is less than the width of the other end of the first tapered waveguide 7111. For example, the first waveguide 711 includes a first tapered waveguide 7111a, a first tapered waveguide 7111b, a first tapered waveguide 7111n, and the like, which may have different lengths; and side surface inclinations of the first tapered waveguide 7111a, the first tapered waveguide 7111b, the first tapered waveguide 7111n, and the like may be different, such that the first waveguide 711 has a discontinuous tapered waveguide structure.

In some embodiments, the multiple segments of first tapered waveguide 7111 in the first waveguide 711 may be symmetric tapered waveguides, but are not limited to symmetric tapered waveguides.

In some embodiments, the second waveguide 712 includes multiple segments of second tapered waveguides 7121 sequentially connected, and the width of one end of the second tapered waveguide 7121 is greater than the width of the other end of the second tapered waveguide 7121. For example, the second waveguide 712 includes a second tapered waveguide 7121a, a second tapered waveguide 7121b, a second tapered waveguide 7121n, and the like, which may have different lengths. The side surface inclinations of the second tapered waveguide 7121a, the second tapered waveguide 7121b, the second tapered waveguide 7121n, and the like may be different, such that the second waveguide 712 has a discontinuous tapered waveguide structure.

In some embodiments, multiple segments of second tapered waveguide 7121 in the second waveguide 712 may be symmetric tapered waveguides, but are not limited to symmetric tapered waveguides.

FIG. 44 is a cross-sectional view in a D-D direction of FIG. 10; and FIG. 44 shows a cross-sectional structure of a connecting portion. As shown in FIG. 44, the width of the connecting portion 720 at D-D is less than the width of the first waveguide 711 at C-C.

FIG. 45 is a cross-sectional view in an E-E direction of FIG. 10; FIG. 46 is a cross-sectional view in an F-F direction of FIG. 11; FIG. 47 is a partial enlarged view of a polarization rotator-splitter according to some embodiments of the present disclosure; and FIG. 45 to FIG. 47 show a structure of a mode coupling portion. As shown in FIG. 45 to FIG. 47, the first coupling waveguide 731 includes a first side surface 7311, and the first side surface 7311 is located on the side surface of the first coupling waveguide 731 facing the second coupling waveguide 732; the second coupling waveguide 732 includes a second side surface 7321, and the second side surface 7321 is located on the side surface of the second coupling waveguide 732 facing the first coupling waveguide 731. The gap between the first side surface 7311 and the second side surface 7321 is a first preset value that is approximately 0.3 μm. For example, the first preset value is greater than 0 μm and lower than 0.3 μm, such as 0.1 μm, 0.15 μm and 0.2 μm.

In some embodiments, the mode coupling portion 730 further includes a curved waveguide 733, and the curved waveguide 733 is provided at one end of the second coupling waveguide 732. For example, one end of the curved waveguide 733 is away from the side of the connecting portion 720, and the other end of the curved waveguide 733 is connected to one end of the second coupling waveguide 732. One end of the curved waveguide 733 extends in a direction away from the connecting portion 720, and the curved waveguide 733 is configured to reduce coupling of the beam from the second coupling waveguide 732 to the connecting portion 720, thereby ensuring the performance of the polarization rotator-splitter.

In some embodiments, the curved waveguide 733 may be an arc waveguide, a spiral waveguide, or the like.

In some embodiments, the curved waveguide 733 is located at the side of the straight optical waveguide 722, so as to increase a distance between the curved waveguide 733 and the straight optical waveguide 722, and reduce coupling of the beam from the second coupling waveguide 732 to the straight optical waveguide 722.

In some embodiments, the first side surface 7311 is a continuous and flat side surface, and the second side surface 7321 is a continuous and flat side surface. For example, the first coupling waveguide 731 is a symmetric tapered waveguide, so as to form a continuous first side surface 7311 on the side of the first coupling waveguide 731; and the second coupling waveguide 732 is a symmetric tapered waveguide, so as to form a continuous second side surface 7321 on the side of the second coupling waveguide 732. Of course, in the embodiments of the present disclosure, the first coupling waveguide 731 and the second coupling waveguide 732 are not limited to the symmetric tapered waveguides.

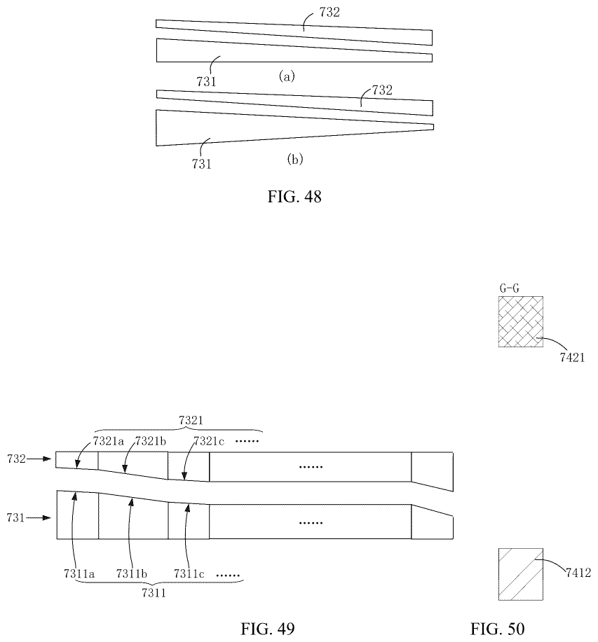

FIG. 48 is a structural diagram of another mode coupling portion according to some embodiments of the present disclosure. In FIG. 48, (a) and (b) respectively show a structure of a mode coupling portion. As shown in FIG. 48, in the mode coupling portion 730, both the first coupling waveguide 731 and the second coupling waveguide 732 are the asymmetric tapered waveguides; or the first coupling waveguide 731 is the symmetric tapered waveguide and the second coupling waveguide 732 is the asymmetric tapered waveguide. Of course, in the embodiments of the present disclosure, the shapes of the first coupling waveguide 731 and the second coupling waveguide 732 are not limited thereto.

FIG. 49 is a structural diagram of another mode coupling section according to some embodiments of the present disclosure and FIG. 49 shows a multi-segment mode coupling portion. As shown in FIG. 49, in some embodiments, the first coupling waveguide 731 includes multi-segment waveguides, where the multi-segment waveguides are sequentially connected and include multi-segment tapered waveguides, straight optical waveguides, and the like. Sides of multi-segment waveguides are sequentially connected to form an uneven first side surface 7311, that is, the first side surface 7311 includes multiple side surfaces sequentially connected.

In some embodiments, on sides of the multi-segment waveguides in the first coupling waveguide 731, a first sub-side surface 7311a, a first sub-side surface 7311b, a first sub-side surface 7311c, and the like are respectively provided; and the first sub-side surface 7311a, the first sub-side surface 7311b, the first sub-side surface 7311c, and the like are sequentially connected to form the first side surface 7311.

In some embodiments, the second coupling waveguide 732 includes the multi-segment waveguides, and the multi-segment waveguides are sequentially connected and include the multi-segment tapered waveguides, the straight optical waveguides, and the like. The sides of the multi-segment waveguides are sequentially connected to form an uneven second side surface 7321, that is, the second side surface 7321 includes multiple side surfaces sequentially connected.

In some embodiments, on sides of the multi-segment waveguides in the second coupling waveguide 732, a second sub-side surface 7321a, a second sub-side surface 7321b, a second sub-side surface 7321c, and the like are respectively provided; and the second sub-side surface 7321a, the second sub-side surface 7321b, the second sub-side surface 7321c, and the like are sequentially connected to form the second side surface 7321.

In some embodiments, a gap between the first sub-side surface 7311a and the second sub-side surface 7321a is a first preset value, a gap between the first sub-side surface 7311b and the second sub-side surface 7321b is a first preset value, a gap between the first sub-side surface 7311c and the second sub-side surface 7321c is a first preset value, and the like.

FIG. 50 is a cross-sectional view in a G-G direction of FIG. 39, and FIG. 50 shows a cross-sectional structure of a beam splitting portion. As shown in FIG. 50, a gap between the first straight optical waveguide 7412 and the second straight optical waveguide 7421 is greater than the width of the first straight optical waveguide 7412, and the gap between the first straight optical waveguide 7412 and the second straight optical waveguide 7421 is greater than the width of the second straight optical waveguide 7421.

Comparison of cross-sectional views shown in FIG. 50 and FIG. 46 shows that the gap between the first straight optical waveguide 7412 and the second straight optical waveguide 7421 is greater than the first preset value. For example, the gap between the first straight optical waveguide 7412 and the second straight optical waveguide 7421 is ten times the first preset value, and the like.

In some embodiments, according to the principle of optical path reversibility, two beams of the TE₀ polarized light are input from the end of the beam splitting portion 740, such that two beams of the TE₀ polarized light can be multiplexed into one polarized beam including the TM₀ polarized light and the TE₀ polarized light, that is, polarization rotation beam combining is implemented by using the polarization rotator-splitter 700. Specifically: one beam of the TE₀ polarized light is input from the end of the fourth waveguide 742, is transmitted in the direction opposite to the polarization rotator-splitter 700, and undergoes mode hybridization in the polarization rotator-splitter 700, and finally TM₀ polarized light is output at one end of the mode conversion portion 710; one beam of the TE₀ polarized light is input from the end of the third waveguide 741, transmitted in the direction opposite to the polarization rotator-splitter 700, and is output at one end of the mode conversion portion 710; and the TM₀ polarized light and the TE₀ polarized light are combined into one beam at one end of the mode conversion portion 710.

Based on the second waveguide 712, the polarization rotator-splitter 700 provided by the embodiments of the present disclosure is suitable for optical links with a relatively thick waveguide layer, such as heterogeneously integrated optoelectronic chips. The polarization rotator-splitter 700 provided by the embodiments of the present disclosure has a structure that is easy to fabricate, a small device size, a large fabrication tolerance, good operating bandwidth performance, low loss and a good polarization extinction ratio.

The polarization rotator-splitter 700 provided by the embodiments of the present disclosure is not limited to use in the optical chip 400 provided by the above embodiments, but may also be used in other optical chips involving polarization-multiplexed beams.

The above descriptions are merely specific embodiments of the present disclosure, but the scope of protection of the present disclosure is not limited thereto. Any of those skilled in the art can think of changes or substitutions within the technical scope of the present disclosure, and these changes or substitutions shall all be included within the scope of protection of the present disclosure. Therefore, the scope of protection of the present disclosure shall be subject to the scope of protection of the claims.

What is claimed is:

1. An optical module, comprising:
a circuit board;
an optical chip, electrically connected to the circuit board; and
a light source, comprising a laser assembly, wherein the laser assembly is electrically connected to the circuit board, and is configured to generate a beam with a specific wavelength and input the beam into the optical chip; and the laser assembly comprises a semiconductor gain chip and a wavelength tuning chip, the semiconductor gain chip is configured to emit a beam in a wavelength range, and the wavelength tuning chip and the semiconductor gain chip form a resonant cavity, wherein the wavelength tuning chip comprises:
an input coupler, configured to receive a beam emitted by the semiconductor gain chip and transmit the beam with a specific wavelength to the semiconductor gain chip;
a power splitter, connected to the input coupler, wherein the power splitter is configured to split the beam input from the input coupler; and
at least one microring filter, connected to an output end of the power splitter, wherein the microring filter is configured to filter out the beam with a specific wavelength from the beam in a wavelength range; and
the microring filter comprises a silicon waveguide ridge region, a first slab region, and a second slab region; the silicon waveguide ridge region is configured to transmit the beam and generate electron hole pairs during the transmission of the beam; the first slab region is located on one side of the silicon waveguide ridge region, and an N-type doped region is provided in the first slab region; and the second slab region is located on the other side of the silicon waveguide ridge region, a P-type doped region is provided in the second slab region, the P-type doped region and the N-type doped region form a PN junction, and the PN junction is configured to absorb the electron hole pairs in the silicon waveguide ridge region, the first slab region, and the second slab region.

2. The optical module according to claim 1, wherein the microring filter further comprises: a silicon substrate, a cladding layer, and contact electrodes; and the cladding layer is provided on the silicon substrate along an epitaxial growth direction, the silicon waveguide ridge region and the contact electrodes are all located in the cladding layer, and the contact electrodes are electrically connected to the P-type doped region and the N-type doped region to provide a reverse bias for the PN junction.

3. The optical module according to claim 2, wherein the contact electrodes comprise a first contact electrode and a second contact electrode; the first contact electrode is electrically connected to the N-type doped region, and the second contact electrode is electrically connected to the P-type doped region; and a first voltage is applied to the first contact electrode, a second voltage is applied to the second contact electrode, and the first voltage is higher than the second voltage, so as to apply the reverse bias to the PN junction.

4. The optical module according to claim 3, wherein along the epitaxial growth direction, the first contact electrode is provided on the first slab region, and the second contact electrode is provided on the second slab region.

5. The optical module according to claim 3, wherein a width of the first contact electrode is equal to or greater than a width of the N-type doped region, and a width of the second contact electrode is equal to or greater than a width of the P-type doped region.

6. The optical module according to claim 2, wherein the microring filter further comprises a buried layer; the buried layer is provided above the silicon substrate, and the cladding layer is provided above the buried layer;
a thickness of the silicon substrate is greater than a thickness of the buried layer; and a thickness of the cladding layer is greater than a thickness of the silicon substrate.

7. The optical module according to claim 2, wherein the microring filter further comprises a heater; along the epitaxial growth direction, the heater is provided on the cladding layer, and the heater is configured to heat the silicon waveguide ridge region to change the refractive index of the microring filter.

8. The optical module according to claim 2, wherein the wavelength tuning chip is a silicon photonic chip, and the cladding layer is a silicon oxide cladding layer.

9. The optical module according to claim 1, wherein a first preset distance is provided between the N-type doped region and an edge of the silicon waveguide ridge region facing the first slab region, a second preset distance is provided between the P-type doped region and an edge of the silicon waveguide ridge region facing the second slab region, and the first preset distance is equal to the second preset distance.

10. The optical module according to claim 9, wherein the first preset distance ranges from 500 nm to 1 μm.

11. The optical module according to claim 10, wherein the first preset distance is 0.8 μm.

12. The optical module according to claim 1, wherein
the first slab region is located on an outer side of the silicon waveguide ridge region, the first slab region surrounds the silicon waveguide ridge region, and the N-type doped region surrounds the silicon waveguide ridge region; and
the second slab region is located on an inner side of the silicon waveguide ridge region, and the silicon waveguide ridge region surrounds the second slab region and surrounds the P-type doped region.

13. The optical module according to claim 1, wherein a width of the first slab region is the same as a width of the second slab region, the width of the first slab region is greater than a width of the silicon waveguide ridge region, a width of the N-type doped region is less than the width of the first slab region, a width of the P-type doped region is less than the width of the second slab region, and the width of the N-type doped region is the same as the width of the P-type doped region.

14. The optical module according to claim 1, wherein the at least one microring filter comprises:
a first microring filter, connected to a first output end of the power splitter; and
a second microring filter, connected to a second output end of the power splitter, wherein the second microring filter is connected in series to the first microring filter, a perimeter of the second microring filter is different from a perimeter of the first microring filter, and the second microring filter cooperates with the first microring filter, to filter out the beam with a specific wavelength light from the split light.

15. The optical module according to claim 14, wherein the wavelength tuning chip further comprises a phase shifter, the phase shifter is located between the input coupler and the power splitter, and the phase shifter is configured to adjust a wavelength of a beam supported by the resonant cavity, such that the beam with a specific wavelength filtered out by the first microring filter and the second microring filter coincides with the beam in the resonant cavity.

16. The optical module according to claim 1, wherein an optical waveguide of the input coupler is an inclined waveguide, one end face of the semiconductor gain chip is the inclined waveguide, and the inclined waveguide of the input coupler and the inclined waveguide of the semiconductor gain chip are arranged in parallel in an optical path direction.

17. An optical module. comprising:
a circuit board;
an optical chip, electrically connected to the circuit board; and
a light source, comprising a laser assembly, wherein the laser assembly is electrically connected to the circuit board, and is configured to generate a beam with a specific wavelength and input the beam into the optical chip; and the laser assembly comprises a semiconductor gain chip and a wavelength tuning chip, the semiconductor gain chip is configured to emit a beam in a wavelength range, and the wavelength tuning chip and the semiconductor gain chip form a resonant cavity, wherein the wavelength tuning chip comprises:
at least one microring filter, wherein the microring filter is configured to filter out the beam with a specific wavelength from the beam in a wavelength range; and
the microring filter comprises a silicon waveguide ridge region, a first slab region, and a second slab region; the silicon waveguide ridge region is configured to transmit the beam and generate electron hole pairs during the transmission of the beam; the first slab region is located on one side of the silicon waveguide ridge region, and an N-type doped region is provided in the first slab region; and the second slab region is located on the other side of the silicon waveguide ridge region, a P-type doped region is provided in the second slab region, the P-type doped region and the N-type doped region form a PN junction, and the PN junction is configured to absorb the electron hole pairs in the silicon waveguide ridge region, the first slab region, and the second slab region;
the first slab region is located on an outer side of the silicon waveguide ridge region, the first slab region surrounds the silicon waveguide ridge region, and the N-type doped region surrounds the silicon waveguide ridge region; and
the second slab region is located on an inner side of the silicon waveguide ridge region, and the silicon waveguide ridge region surrounds the second slab region and surrounds the P-type doped region.

18. The optical module according to claim 17, wherein the microring filter further comprises: a silicon substrate, a cladding layer, and contact electrodes; and the cladding layer is provided on the silicon substrate along an epitaxial growth direction, the silicon waveguide ridge region and the contact electrodes are all located in the cladding layer, and the contact electrodes are electrically connected to the P-type doped region and the N-type doped region to provide a reverse bias for the PN junction.

19. An optical module, comprising:
a circuit board;
an optical chip, electrically connected to the circuit board; and
a light source, comprising a laser assembly, wherein the laser assembly is electrically connected to the circuit board, and is configured to generate a beam with a specific wavelength and input the beam into the optical chip; and the laser assembly comprises a semiconductor gain chip and a wavelength tuning chip, the semiconductor gain chip is configured to emit a beam in a wavelength range, and the wavelength tuning chip and the semiconductor gain chip form a resonant cavity, wherein the wavelength tuning chip comprises:
an input coupler, configured to receive a beam emitted by the semiconductor gain chip and transmit the beam with a specific wavelength to the semiconductor gain chip;
a power splitter, connected to the input coupler, wherein the power splitter is configured to split the beam input from the input coupler; and
at least one microring filter, connected to an output end of the power splitter, wherein the microring filter is configured to filter out the beam with a specific wavelength from the beam in a wavelength range;
the microring filter comprises a silicon waveguide ridge region, a first slab region, and a second slab region; the silicon waveguide ridge region is configured to transmit the beam and generate electron hole pairs during the transmission of the beam; the first slab region is located on one side of the silicon waveguide ridge region, and an N-type doped region is provided in the first slab region; and the second slab region is located on the other side of the silicon waveguide ridge region, a P-type doped region is provided in the second slab region, the P-type doped region and the N-type doped region form a PN junction, and the PN junction is configured to absorb the electron hole pairs in the silicon waveguide ridge region, the first slab region, and the second slab region; and
the contact electrodes are electrically connected to the P-type doped region and the N-type doped region to supply power to the P-type doped region and the N-type doped region.

20. The optical module according to claim 19, wherein the contact electrodes comprise a first contact electrode and a second contact electrode; the first contact electrode is electrically connected to the N-type doped region, and the second contact electrode is electrically connected to the P-type doped region; and a first voltage is applied to the first contact electrode, a second voltage is applied to the second contact electrode, and the first voltage is higher than the second voltage, so as to apply a reverse bias to the PN junction.
